(19) United States
(12) Patent Application Publication
(10) Pub. No.: US 2023/0224792 A1
(43) Pub. Date: Jul. 13, 2023

(54) DYNAMIC ACTIVATION OF LOCAL BREAKOUT WITH COORDINATION BETWEEN APPLICATION DOMAIN AND MOBILE NETWORK

(71) Applicant: Telefonaktiebolaget LM Ericsson (publ), Stockholm (SE)

(72) Inventors: Jan Backman, Kärna (SE); Jari Vikberg, Järna (SE)

(21) Appl. No.: 17/766,313

(22) PCT Filed: Oct. 2, 2020
(86) PCT No.: PCT/EP2020/077738

§ 371 Date: Apr. 4, 2022

Related U.S. Application Data
(60) Provisional application No. 62/910,767, filed on Oct. 4, 2019.

(51) Int. Cl. H04W 40/02; H04L 45/302; H04L 61/4511; H04W 76/20

(52) U.S. Cl. CPC H04W 40/02; H04L 45/306; H04L 61/4511; H04W 76/20

(57) ABSTRACT

Disclosed herein is a method performed by a network node and a network node performing the method, which implements a DNS function in a mobile network, the method comprising the actions: receiving; a DNS query that originated at a UE; in response to receiving; the DNS query, determining; to trigger dynamic activation of Local Break Out, LBO, for a session of the UE at a breakout site of the mobile network for traffic between the UE and an edge AS site that is connected to the breakout site; and upon determining; to trigger dynamic activation of LBO for the session of the UE at the breakout site of the mobile network for traffic between the UE and the edge AS site, triggering; dynamic activation of LBO for the session of the UE at the breakout site of the mobile network for traffic between the UE and the edge AS site.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

FIG. 1

FIG. 1 illustrates one example network topology (one part of a Mobile Network Operator (MNO) network). This example shows different network site types (local, regional, national). More specifically, a network consists of sites spread in different geographical locations. Functionality is spread to different sites depending on, e.g., requested performance, costs, security, and availability. This can vary between different ambitions of different operators as well as the size of the network. In large networks, there are different numbers of instances for each site type.
Devices/Local networks—The actual device used by a user or a network set up by a user or enterprise outside the control of the operator
   Customer Premises Site (CS), Usage: customer equipment, Manning: unmanned, Security: low, Connectivity: below gigabit per second (Gbps)
Access sites—Local sites which are as close as possible to the users
   Antenna Site (AnS), Usage: antenna and Radio Frequency (RF) equipment (also complete micro/pico), Manning: unmanned, Security: low, Connectivity: 10 Gbps
   Radio Access Site (RS), Usage: telecom functionality, Radio Access Network (RAN) equipment, Manning: unmanned, Security: low, Connectivity: below terabit per second (Tbps)
Distributed sites—Sites which are distributed for reasons of execution or transport efficiency or for local breakout
   Hub Site (HS), Usage: transport equipment, Manning: unmanned, Security: low, Connectivity: below Tbps
   Local Access Site (LA), Usage: telecom functionality including RAN equipment, Manning: mostly unmanned, Security: medium, Connectivity: less than Tbps
   Regional Data Center (RDC), Usage: compute, storage and networking equipment, Manning: 24/7, Security: extremely high, Connectivity: very high bandwidth
National sites—National sites which are typically centralized within an operator's network
   National Access Site (NA), Usage: telecom functionality, Manning: 24/7 (or reachable within hours), Security: high, Connectivity: very high bandwidth
   National Data Center (NDC), Usage: compute, storage and networking equipment, Manning: 24/7, Security: extremely high, Connectivity: very high bandwidth
   Network Operation Center (NOC), Usage: NOC equipment, Manning: 24/7, Security: high, Connectivity: some Gbps
Global sites—Centralized sites which are publicly accessible from anywhere, typically a large data center
   International Data Center (IDC), Usage: compute, storage and networking equipment, Manning: 24/7, Security: extremely high, Connectivity: very high bandwidth
      Note that the CS, AnS, or RS are examples of a “radio site” referred to herein. The LA is an example of a “local site” as referred to herein. An RDC is an example of a “regional site” referred to herein. An NA is an example of a “national site” referred to herein.

### FIG. 2

FIG. 2 illustrates one network solution for traffic routing, e.g., for Application Servers (ASs)/Content Delivery Network (CDN) in a distributed cloud architecture. As illustrated, in this example, a mobile network includes a RAN including radio sites (e.g., base stations such as, e.g., enhanced or evolved Node Bs (eNBs) or New Radio (NR) base stations (gNBs)). In addition, the mobile network includes a core network (e.g., an Evolved Packet Core (EPC) or Fifth Generation (5G) core), where core network functionality (e.g., core network functions) are implemented at a number of sites. In the example of FIG. 2, these sites include a breakout site and a session anchor site. The breakout site may be, for example, a local site as described above with respect to FIG. 1, but is not limited thereto. The session anchor site may be, for example, a national site (also referred to herein as a “central” site) as described above with respect to FIG. 1, but is not limited thereto.

The solution for traffic routing illustrated in FIG. 2 is referred to as a “session breakout” or Local Break Out (LBO) solution. In the session breakout solution, the User Equipment (UE) has a PDU session with a core network User Plane (UP) part located at the session anchor site. In addition, a core network UP is located at the breakout site for the same UE PDU session. At the breakout site, some uplink traffic from the UE is routed to the core network UP part located at the session anchor site and, using LBO, some other uplink traffic from the UE is routed to, e.g., an AS or Domain Name System (DNS) connected to (e.g., an edge of) the breakout site. Note that session breakout is PDU session specific. If the UE has multiple PDU sessions, then each of those PDU sessions can use session breakout.

Session breakout is beneficial in various traffic routing or content delivery scenarios. For example, consider a streaming video service provider. In the normal scenario, the streaming service provider has a corresponding AS that is connected to the session anchor site (e.g., a national site). This AS is responsible for streaming video content to the UEs associated with the video streaming service (e.g., to subscribers of the video streaming service). However, in order to provide an improved experience to the user (e.g., lower latency), it is beneficial for such a streaming video service provider to also have “edge sites” (e.g., “edge ASs”) that are connected to breakout sites (e.g., local sites) and accessible using session breakout. For instance, consider a scenario in which a particular UE has a PDU session that is used by multiple applications including an Internet browser and an application client for streaming video service. Then, for example, an Uplink Classifier (ULCL) in the core UP part directs traffic for the streaming video service to the core UP Function (UPF) at the breakout site via session breakout and directs traffic for the Internet browser to the core UP at the session anchor site.

### SUMMARY

There currently exist certain challenge(s). Using conventional LBO, the LBO is “always on”. In other words, the ULCL in the core UP part is static such that all traffic on the PDU session is always processed in the ULCL. This is very inefficient, particularly when much of the traffic is for services other than the service(s) for which there are local/edge site(s). Further, there is a need for systems and methods for efficiently handling DNS queries when using session breakout. Using conventional technology, LBO is always active at the breakout site, and a DNS server is also implemented at the breakout site. When a DNS query is received from the UE, this DNS query is always first processed by the DNS server at the breakout site. If the DNS server at the breakout site cannot serve the DNS query, then the DNS query is either forwarded to a DNS server at the session anchor site or the UE is redirected to the DNS at the session anchor site. Such a solution is very inefficient because all DNS queries from the UE must be processed by the DNS server at the breakout site even if there is only one edge AS connected (e.g., an edge AS associated with a particular service).

### BRIEF DESCRIPTION OFF THE DRAWINGS

The accompanying drawing figures incorporated in and forming a part of this specification illustrate several aspects of the disclosure, and together with the description serve to explain the principles of the disclosure.

FIG. 1 illustrates one example network topology (one part of a Mobile Network Operator (MNO) network);

FIG. 2 illustrates one network solution for traffic routing;

FIG. 3 illustrates one example of a cellular communications system 300, which also referred to herein as a mobile network, in which embodiments of the present disclosure may be implemented;

FIG. 4 illustrates a wireless communication system represented as a 5G network architecture;

FIG. 5 illustrates a 5G network architecture using service-based interfaces between the NFs in the CP;

FIG. 6 shows the internal architecture for an exemplifying gNB;

FIGS. 7A-7H illustrate a process for enabling and providing dynamic activation (and deactivation) of LBO at a breakout site;

FIG. 8 is a flow chart that illustrates the operation of a DNS function in accordance with some embodiments of the present disclosure;

FIGS. 9A-9H illustrate an alternative embodiment of the present disclosure;

FIG. 10 is a flow chart that illustrates the operation of a DNS function in accordance with some embodiments of the present disclosure;

FIG. 11 illustrates an embodiment in which a DNS function is integrated into a core UP part;

FIG. 12 illustrates an embodiment in which an edge site DNS is replaced with a breakout site DNS;

FIG. 13 is a schematic block diagram of a network node 130 according to some embodiments of the present disclosure;

FIG. 14 is a schematic block diagram that illustrates a virtualized embodiment of a network node according to some embodiments of the present disclosure;

FIG. 15 is a schematic block diagram of a network node according to some other embodiments of the present disclosure;

FIG. 16 is a schematic block diagram of a UE according to some embodiments of the present disclosure;

FIG. 17 is a schematic block diagram of a UE according to some other embodiments of the present disclosure.

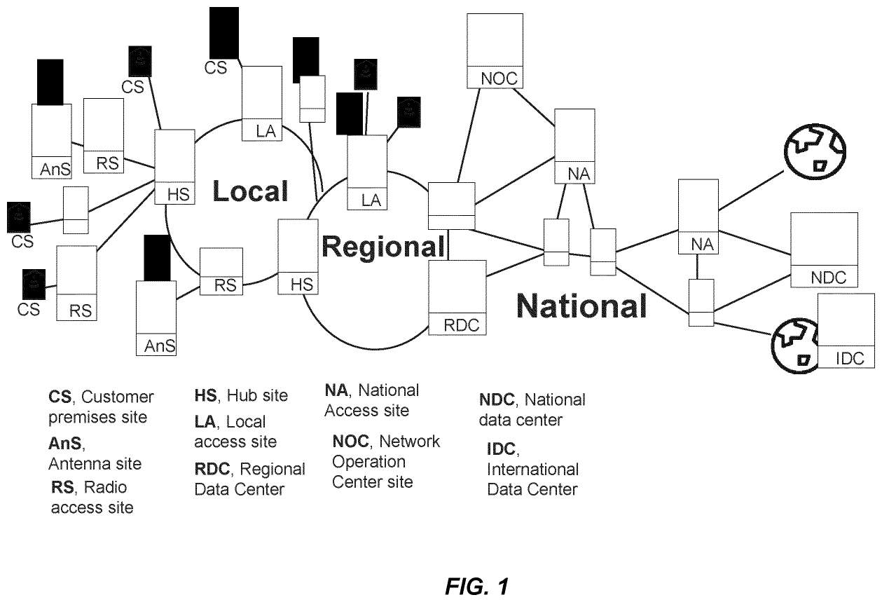

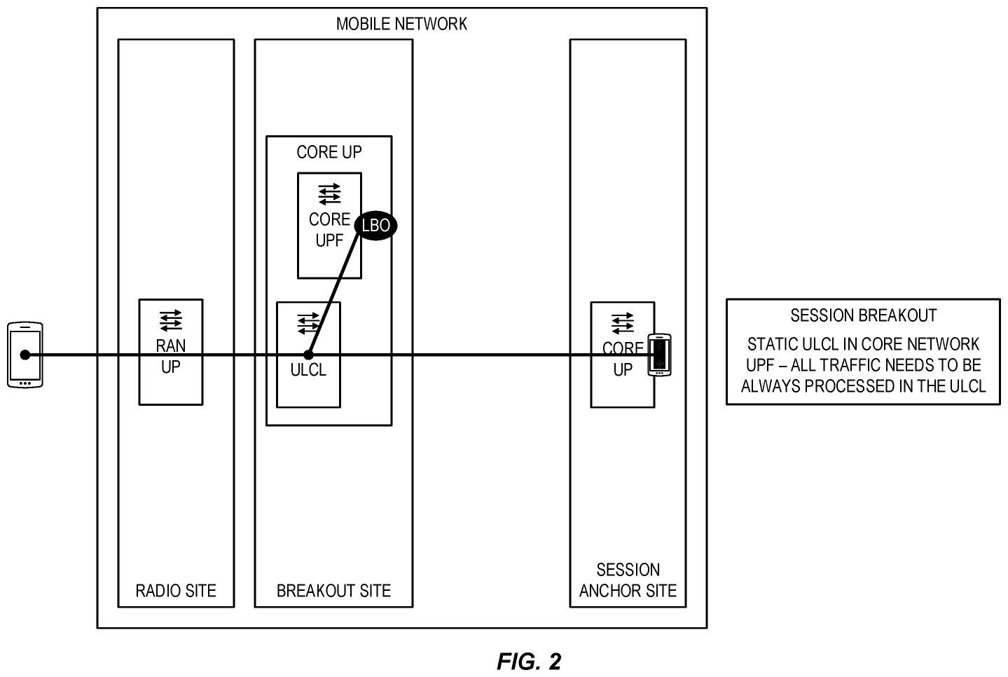

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network, also called Next Generation Radio Access Network (NG-RAN), or an enhanced or evolved Node B (eNB) in a 3GPP Long Term Evolution (LTE) network), also called Evolved Universal Terrestrial Radio Access Network (E-UTRAN), a high-power or macro base station, a low-power base station (e.g., a micro base station, a pico base station, a home eNB, or the like), and a relay node. Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane (UP) Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

It should also be noted that the embodiments herein focus on the use of a Protocol Data Unit (PDU) session. However, a PDU session is a 5G concept, and the embodiments are equally applicable to other types of connections (e.g., a Packet Data Network (PDN) connection such as that utilized in a Fourth Generation (4G) network).

Certain aspects of the present disclosure and their embodiments may provide solutions to the aforementioned or other challenges. Systems and methods are disclosed herein for dynamically activating/deactivating Local Break Out (LBO) and efficiently handling Domain Name System (DNS) queries in a mobile network. In some embodiments, LBO (i.e., Uplink Classifier (ULCL)/UPF at the breakout site that provide LBO) is dynamically activated when a distributed Application Server (AS) (also referred to herein as an “edge AS” or “edge site AS”) is selected by the application layer. Once the distributed application server is not used anymore, the ULCL/UPF is deactivated. In some embodiments, dynamic activation/deactivation LBO is based on the AS provider and the mobile network operator having a Service Level Agreement (SLA), which is referred to herein as a “traffic routing SLA” that defines (1) the application(s) (edge AS(s)) that are applicable for this functionality (e.g., defined by domain name(s), e.g., Fully Qualified Domain Name(s) (FQDN(s))), (2) the location(s) of edge site(s) at which the edge AS(s) are placed, referred to herein as “edge site/AS location”, (3) optionally (depending on the particular embodiment) an Internet Protocol (IP) address for an edge DNS server, and (4) optionally (depending on the particular embodiment) an IP address range for the edge site or the edge AS. With the above information, the mobile network can utilize the current location of the UE (e.g., determined in any desired manner such as, e.g., via the IP address of the UE) to perform AS selection. If the edge AS is selected, then the mobile network triggers activation of LBO (i.e., triggers activation of the ULCL and UPF at the breakout site for LBO to the edge site).

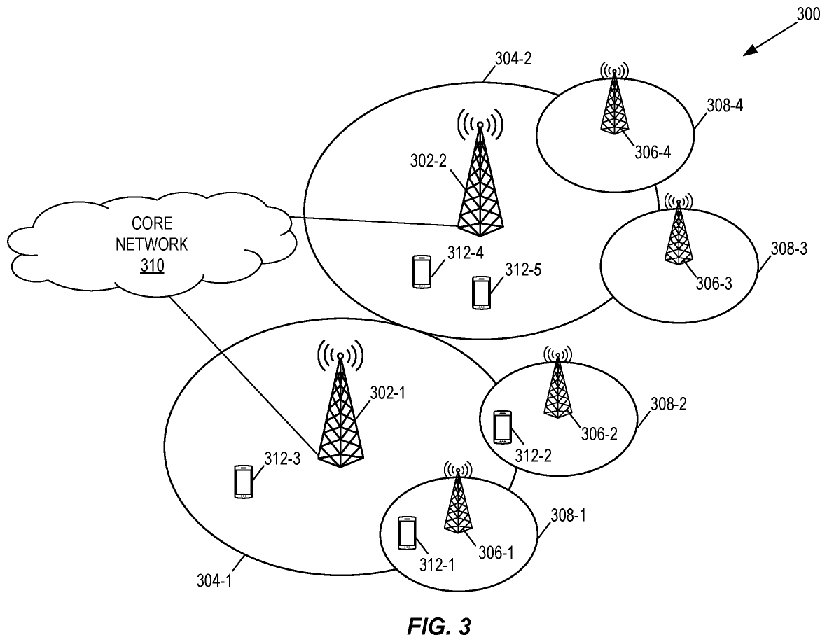

### FIG. 3

In this regard, FIG. 3 illustrates one example of a cellular communications system 300, which also referred to herein as a mobile network, in which embodiments of the present disclosure may be implemented. In the embodiments described herein, the cellular communications system 300 is a 5G System (5GS) including a NG-RAN and a 5G Core (5GC). However, the embodiments described herein are equally applicable to an Evolved Packet System (EPS) including a LTE RAN and an Evolved Packet Core (EPC). In this example, the RAN includes base stations 302-1 and 302-2, which in NG-RAN are referred to as gNBs or Next Generation eNBs (NG-eNBs), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308.

Note that the base stations 302 each include a Control Plane (CP) part (sometimes referred to herein as a RAN CP or RAN CP part) and one or more UP parts (sometimes referred to herein as RAN UP or RAN UP part).

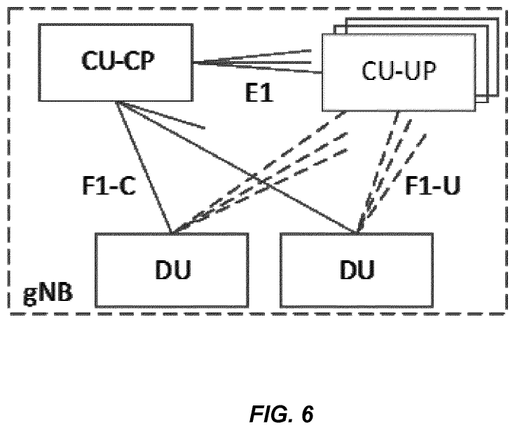

The cellular communications system 300 also includes a core network 310, which in the 5GS is referred to as the 5GC. The base stations 302 (and optionally the low power nodes 306) are connected to the core network 310. For example, the base stations 302 are located at corresponding radio sites. Note, however, that in some embodiments the functionality of the RAN may be split into multiple parts (see, e.g., FIG. 6 described below). For example, looking at FIG. 6, the Distributed Unit (DU) is typically located at the radio site, while the Central Unit (CU) CP (CU-CP) and CU UP (CU-UP) may be either at the radio site or at any site higher up in the network (e.g., at the local site, regional site, or national site). In addition, the core network 310 includes UP parts (e.g., UPFs) located at various local, regional, and national (i.e., central) sites.

The base stations 302 and the low power nodes 306 provide service to wireless devices 312-1 through 312-5 in the corresponding cells 304 and 308. The wireless devices 312-1 through 312-5 are generally referred to herein collectively as wireless devices 312 and individually as wireless device 312. The wireless devices 312 are also sometimes referred to herein as UEs.

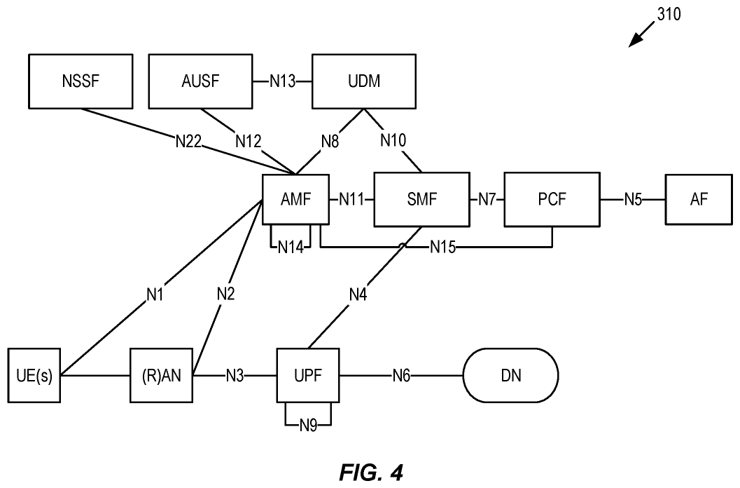

### FIG. 4

FIG. 4 illustrates a wireless communication system represented as a 5G network architecture composed of core NFs, where interaction between any two NFs is represented by a point-to-point reference point/interface. FIG. 4 can be viewed as one particular implementation of the system 300 of FIG. 3.

Seen from the access side the 5G network architecture shown in FIG. 4 comprises a plurality of UEs connected to either a RAN or an Access Network (AN) as well as an AMF. Typically, the R(AN) comprises base stations, e.g. such as eNBs or gNBs or similar. Seen from the core network side, the 5G core NFs shown in FIG. 4 include a NSSF, an AUSF, a UDM, an AMF, a SMF, a PCF, and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which provides the possibility for the AMF and SMF to interact in different ways. N4 is used by the SMF and UPF so that the UPF can be set using the control signal generated by the SMF, and the UPF can report its state to the SMF. N5 is the reference point for the connection between the PCF and AF. N6 is the reference point for the connection between the UPF and Data Network (DN). N9 is the reference point for the connection between different UPFs, and N14 is the reference point connecting between different AMFs, respectively. N15 and N7 are defined since the PCF applies policy to the AMF and SMF, respectively. N12 is required for the AMF to perform authentication of the UE. N8 and N10 are defined because the subscription data of the UE is required for the AMF and SMF. N22 is the reference point for the connection between the AMF and NSSF.

The 5GC network aims at separating UP and CP. The UP carries user traffic while the CP carries signaling in the network. In FIG. 4, the UPF is in the UP and all other NFs, i.e., the AMF, SMF, PCF, AF, AUSF, and UDM, are in the CP. Separating the UP and CP guarantees each plane resource to be scaled independently. It also allows UPFs to be deployed separately from CP Functions (CPFs) in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the CP. Separated AMF and SMF allow independent evolution and scaling. Other CPFs like the PCF and AUSF can be separated as shown in FIG. 4. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

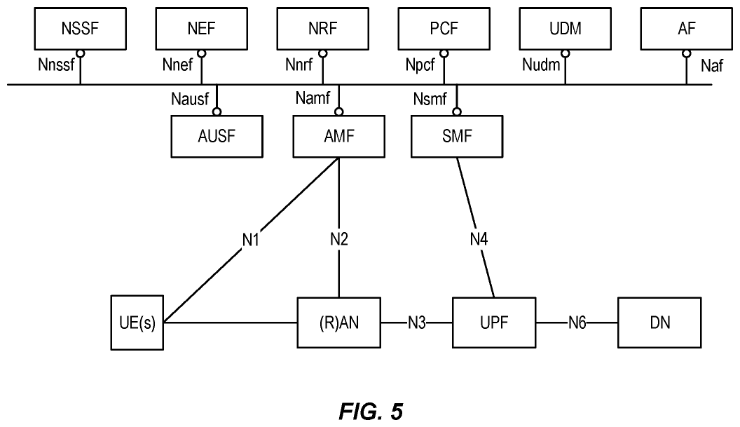

### FIG. 5

FIG. 5 illustrates a 5G network architecture using service-based interfaces between the NFs in the CP, instead of the point-to-point reference points/interfaces used in the 5G network architecture of FIG. 4. However, the NFs described above with reference to FIG. 4 correspond to the NFs shown in FIG. 5. The service(s) etc. that a NF provides to other authorized NFs can be exposed to the authorized NFs through the service-based interface. In FIG. 5 the service based interfaces are indicated by the letter “N” followed by the name of the NF, e.g. Namf for the service based interface of the AMF and Nsmf for the service based interface of the SMF etc. The NEF and the NRF in FIG. 5 are not shown in FIG. 4 discussed above. However, it should be clarified that all NFs depicted in FIG. 4 can interact with the NEF and the NRF of FIG. 5 as necessary, though not explicitly indicated in FIG. 4.

Some properties of the NFs shown in FIGS. 4 and 5 may be described in the following manner. The AMF provides UE-based authentication, authorization, mobility management, etc. A UE even using multiple access technologies is basically connected to a single AMF because the AMF is independent of the access technologies. The SMF is responsible for session management and allocates IP addresses to UEs based on the PDU session concept. It also selects and controls the UPF for data transfer. If a UE has multiple PDU sessions, different SMFs may be allocated to each session to manage them individually and possibly provide different functionalities per PDU session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The DN, not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

### FIG. 6

FIG. 6 shows the internal architecture for an exemplifying gNB, i.e. referring to a base station supporting NR RAT in the (R)AN of FIGS. 4 and 5 and called NG-RAN in this case (see 3GPP Technical Specification (TS) 38.401 for stage-2 description of NG-RAN). FIG. 6 assumes that both Higher Layer Split (HLS) and CP-UP split have been adopted within the gNB. The NG-RAN may also contain LTE NG-eNBs and HLS may later be supported also for NG-eNBs.

HLS means that the gNB is divided into a CU and a DU. CP-UP split further divides the CU into a CU-CP and a CU-UP and this part is currently being standardized in 3GPP. Note that the CU-CP is also sometimes referred to herein as RAN CP. The related study report is 3GPP Technical Report (TR) 38.806. The CU-CP hosts the Radio Resource Control (RRC) protocol and the Packet Data Convergence Protocol (PDCP) used for the CP part and the CU-UP hosts the Service Data Adaptation Protocol (SDAP) protocol and the PDCP used for the UP part. The CU-CP is controlling the CU-UP via an E1 interface. Although not shown in FIG. 6, the CU-CP is the function that terminates the N2 interface from the AMF in 5GC, and the CU-UP is the function terminating the N3 interface from the UPF in 5GC (e.g., in relation to FIGS. 4 and 5). Logically, a UE has one CU-UP per PDU session. Other terms used for N2 and N3 interfaces in 3GPP are Next Generation CP Interface (NG-C) and Next Generation UP Interface (NG-U).

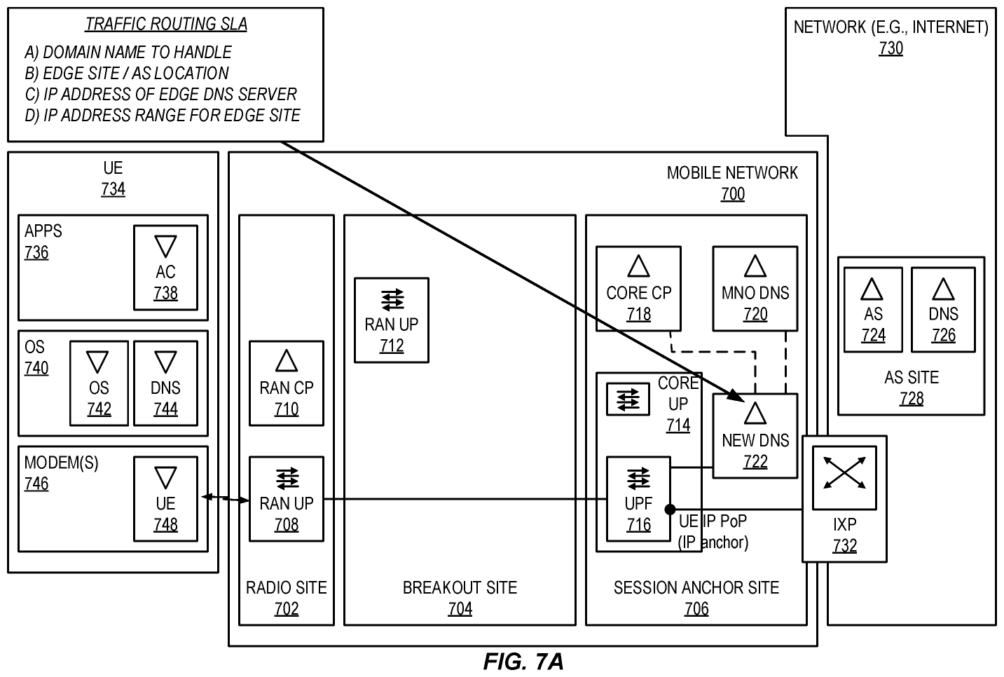

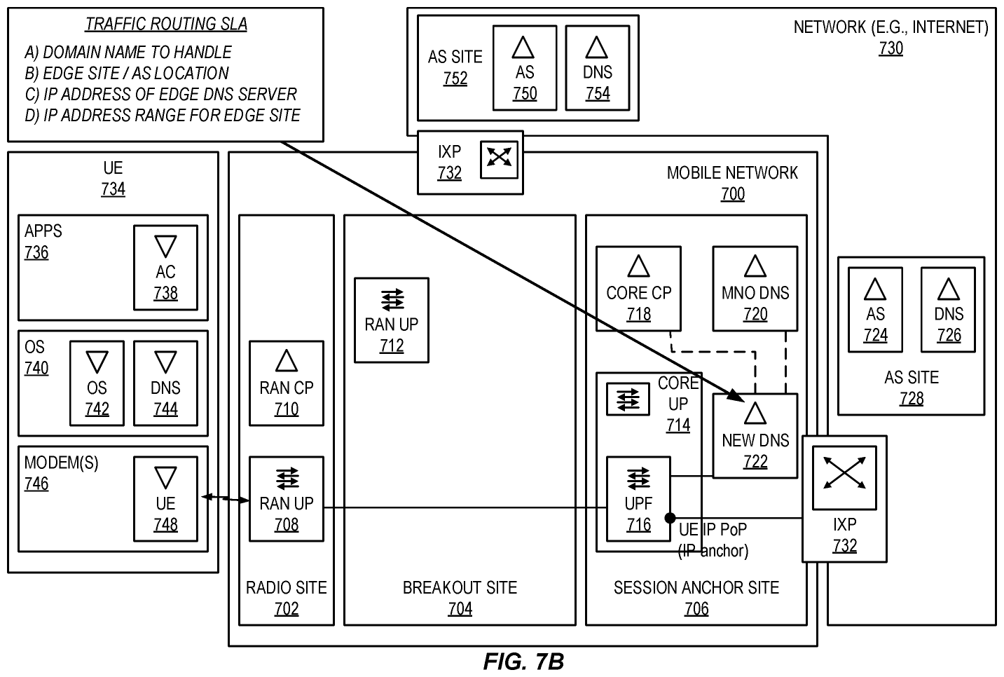

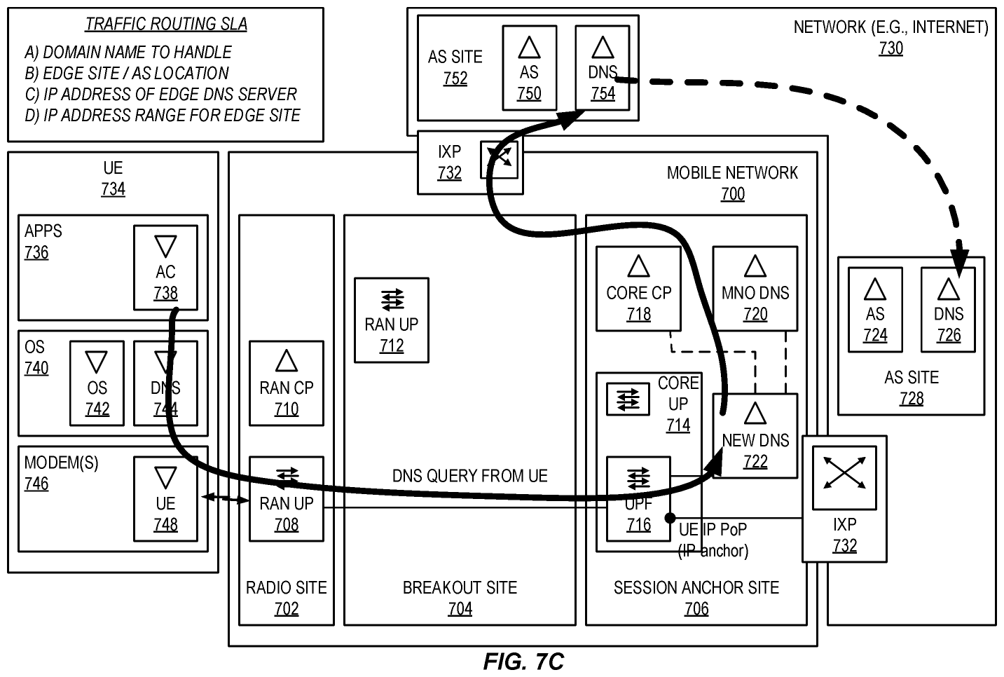

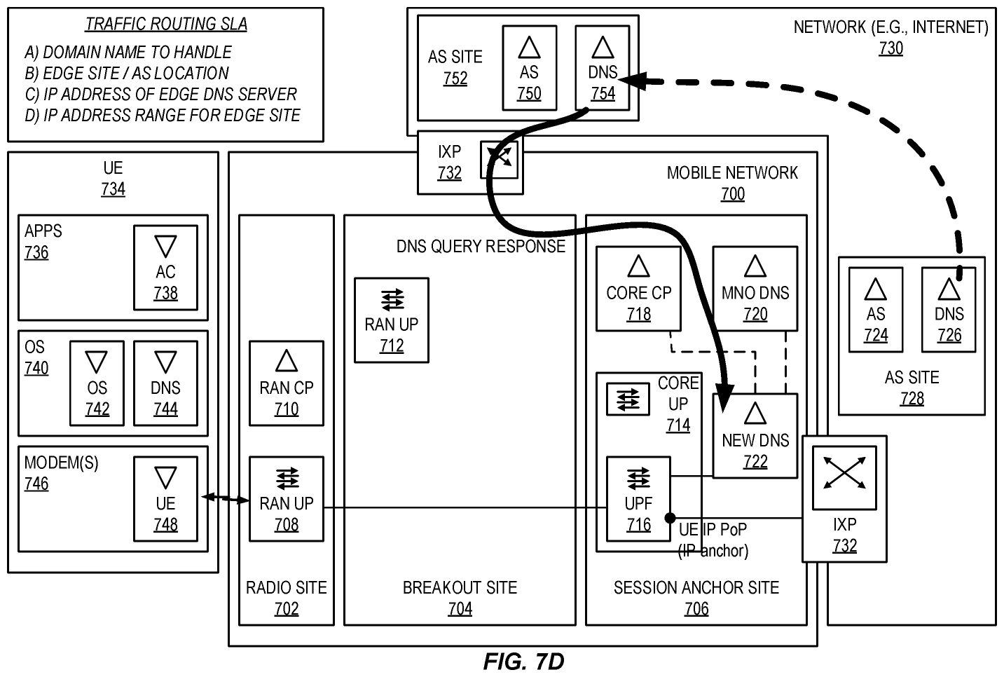

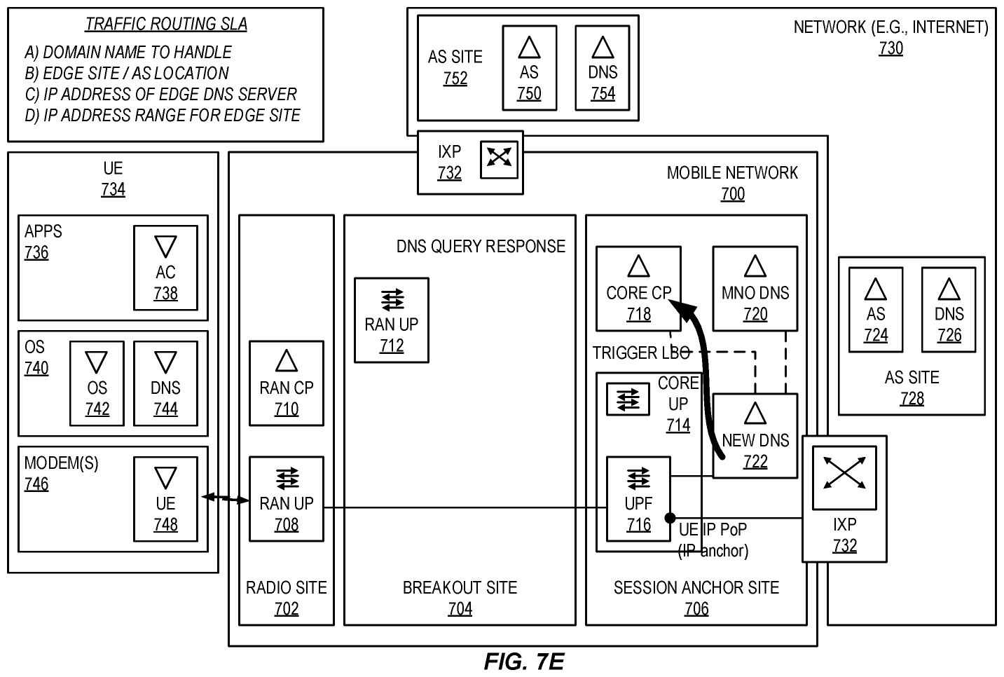

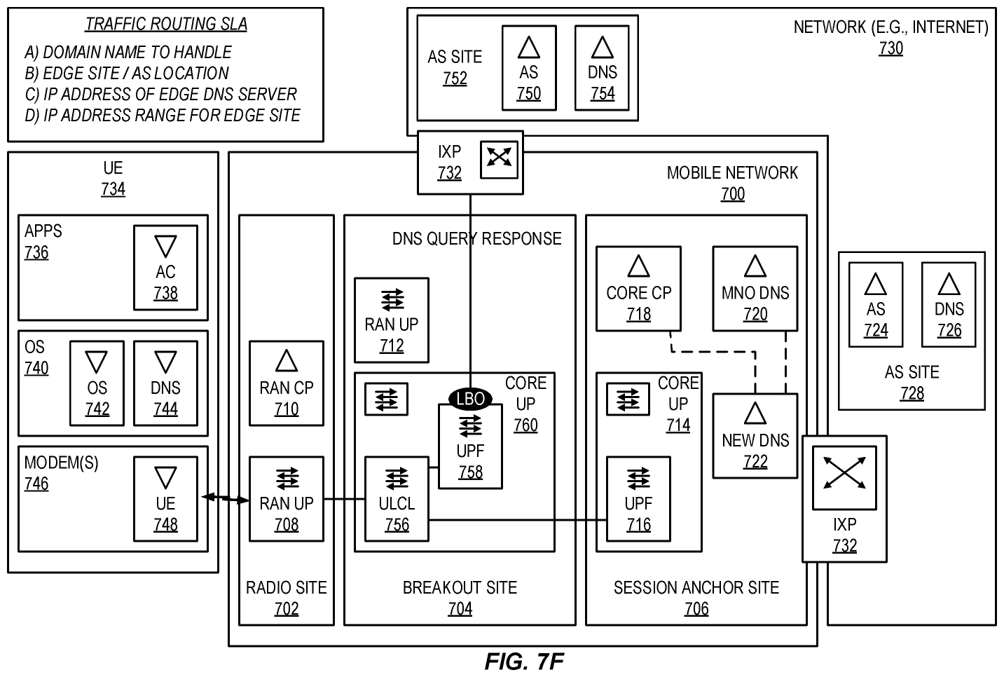

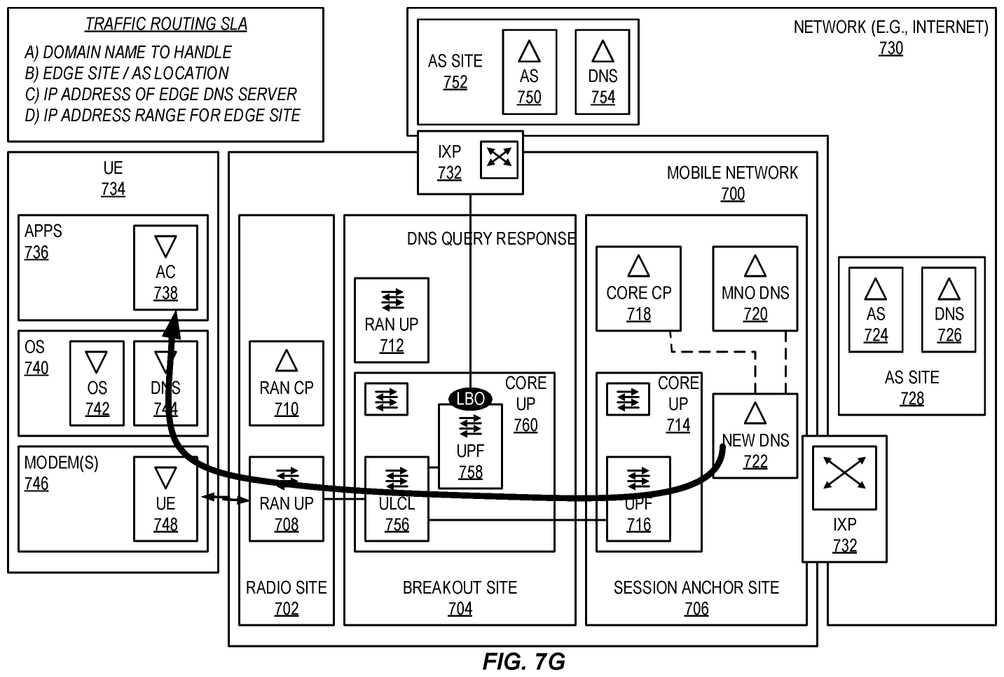

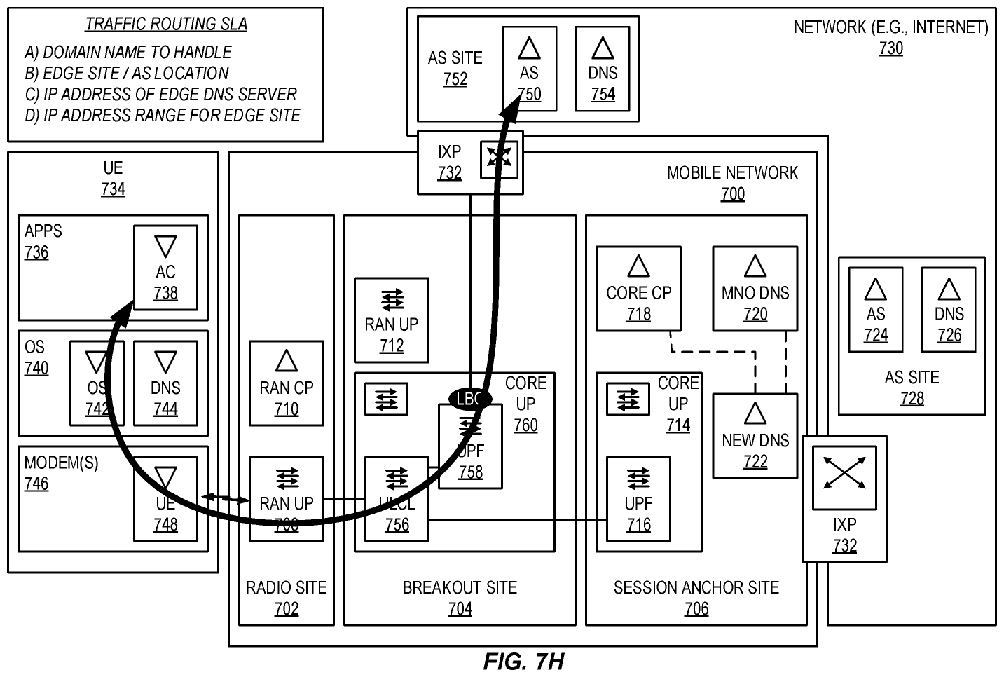

FIGS. 7A through 7H illustrate a system and corresponding method for dynamically activating LBO and efficiently handling a DNS query in one example of a mobile network 700. As illustrated, the mobile network 700 includes a radio site 702, a breakout site 704, and a session anchor site 706. The radio site 702 includes a RAN UP part 708 and a RAN CP part 710. The breakout site 704 may include a RAN UP part 712. The session anchor site 706 includes a core UP part 714, which includes a UPF 716, a core CP part 718, and a Mobile Network Operator (MNO) DNS 720. As discussed below in detail, the session anchor site 706 also includes a new DNS function 722. In this example, the new DNS function 722 is separate from the core UP part 714; however, the new DNS function 722 may alternatively be part of the core UP part 714.

The UPF 716 at the session anchor site 706 is connected to an AS 724 and an AS site DNS 726 located at an AS site 728, which is in the illustrated example part of a DN 730 (e.g., the Internet), through a gateway, which is in this example an Internet Exchange Point (IXP) 732.

A UE 734 is connected to the mobile network 700. The UE 734 includes one or more applications 736 including an Application Client (AC) 738 associated with the AS 724, an Operating System (OS) 740 that includes an OS function 742 and an DNS function 744, and one or more modems 746 including a 3GPP UE modem 748.

A process for enabling and providing dynamic activation (and deactivation) of LBO at the breakout site will now be described with respect to FIGS. 7A through 7H.

### FIG. 7A

As illustrated in FIG. 7A, a traffic routing SLA is defined between the operator of the mobile network 700 and the service provider associated with the AS 724. The traffic routing SLA includes: (A) a domain name (e.g., FQDN) associated with the AS 724 (and thus an edge AS 750—see, e.g., FIG. 7B), (B) an edge site or edge AS location (i.e., location information for the edge AS 750 or an edge AS site 752 at which the edge AS 750 is located), (C) an IP address of an edge site DNS 754 (see, e.g., FIG. 7B), and (D) an IP address range of the edge AS site 752 (i.e., IP address range for the edge AS 750 and the edge site DNS 754) or an IP address range for the edge AS 750, depending on the particular embodiment. The information in the traffic routing SLA is utilized by the operator to configure the mobile network 700. In particular, in this example, the information in the traffic routing SLA is used to configure the new DNS function 722.

### FIG. 7B

Looking at FIG. 7B, the above traffic routing SLA information is for a specific distributed AS site (also referred to herein as an “edge site” or “edge AS site”), which is the edge AS site 752 in this example. Note that when there are multiple such distributed AS sites, then each of these may have its own traffic routing SLA with the related information. Also note that there may be multiple such traffic routing SLAs per AS site. So, these AS sites can contain multiple different ASs, which may have their own traffic routing SLAs. The traffic routing SLA information is made available in the new DNS function 722 and is used as described in the following. For the logic described in this embodiment, the new DNS function 722 uses the following information and capabilities in addition to the traffic routing SLA information:
i. Information about the current UE location within the mobile network. This location needs to be in a format that can be mapped to the edge site/AS location in the Traffic Routing SLA. There are different ways for how the new DNS function can get the UE location, as will be appreciated by one of skill in the art. Any such way may be used.
ii. Capability to trigger dynamic activation and/or deactivation of a distributed ULCL/UPF at a specific network site (e.g., at the breakout site 704 in this example) via the mobile network core CP part 718. In addition, the new DNS function 722 is able to identify the current core CP node for the UE's PDU session, for example a specific SMF for a specific UE PDU session.

In the illustrated example, the new DNS function 722 is shown as a separate entity from the MNO DNS 720, but these can also be the same entity.

As also illustrated in FIG. 7B, the service provider deploys the edge AS 750 and the edge site DNS 754 at the edge AS site 752. The edge AS site 752 is said to be closer to a site that is “further out” in the mobile network 700 in that it is connected to the breakout site 704 rather than the session anchor site 706. Note that the edge AS 750 is the same as or some limited version of the AS 724 (e.g., the AS 724 may be an AS for a video streaming service and the edge AS 750 may be a cache for some subset of the video content that is available from the AS 724).

### FIGS. 7C-7H

As illustrated in FIG. 7C, the UE 734, and in particular the AC 738 at the UE 734, triggers the DNS client 744 to perform a DNS query to resolve an IP address of the AS 724. The response may either be an IP address of the edge AS 750 or the (central) AS 724. The DNS query from the UE 734 is propagated through the mobile network 700 to the new DNS function 722. In this embodiment, the new DNS function 722 (which may be a DNS server) first checks if the FQDN included in the DNS query is part of any traffic routing SLA information set defined by any traffic routing SLA(s) for which the new DNS 722 has been configured. If this is not the case, then the new DNS function 722 forwards the DNS query to the DNS infrastructure in the normal manner (e.g., via the MNO DNS 720 or other DNS server). If the FQDN included in the DNS query is part of one or more traffic routing SLA information sets, then the new DNS function 722 checks the current location of the UE 734 against the edge site/AS location in the traffic routing SLA information set(s) that matched the FQDN included in the DNS query. If the current location of the UE 734 does not match the edge site/AS location of any of the matching traffic routing SLA information set(s), then the new DNS function 722 forwards the DNS query to the DNS infrastructure in the normal manner, e.g. via the MNO DNS 720 or other DNS servers.

If the UE location matches the edge site/AS location from more than one of the traffic routing SLA information sets that matched the FQDN included in the DNS query, then the new DNS function 722 selects the traffic routing SLA information set for which the UE location most closely matches (e.g., is closest to) the edge site/AS location. If there is only one traffic routing SLA information set for which the UE location matches the edge site/AS location, then that traffic routing SLA information set is selected. In the illustrated example, the selected SLA information set is that for the edge AS site 752 (i.e., the edge AS 750), and the new DNS function 722 forwards the DNS query to the IP address for edge DNS server 754 defined in the traffic routing SLA for the selected edge site/AS, as illustrated in FIG. 7C. Note that in the discussion above, the new DNS function 722 first checks the FQDN and then checks location. However, the new DNS function 722 may alternatively check the location first and then check the FQDN.

It should be noted that the manner in which the new DNS function 722 determines whether the UE location matches an edge site/AS location depends on how these two locations are defined. For example, the edge site/AS location may, in some embodiments, be defined at a point (e.g., a physical address, a set of Global Positioning System (GPS) coordinates, or the like) where the UE location matches the edge site/AS location if, e.g., the UE location is within a predefined distance from that point or within a predefined geographic region. As another example, in some other embodiments, the edge site/AS location may be defined as a geographic region where the UE location matches the edge site/AS location if, e.g., the UE location is within that geographic region. Note that the above examples for determining whether the UE location matches the edge site/AS location are only examples. Any suitable technique may be used.

As illustrated in FIG. 7C, the edge site DNS 754 may decide to serve the DNS query locally or the edge site DNS 754 may forward the DNS query to a more central site DNS (e.g., the AS site DNS 726). In the latter case, the edge AS DNS server location is used by the central site DNS to decide where the AS should be selected. In the shown example, the edge AS 750 at the edge AS site 752 is selected, either by the edge site DNS 754 or by the central site DNS. The DNS response is returned to the new DNS function 722, as illustrated in FIG. 7D.

The new DNS function 722 checks if the IP address returned in the DNS response matches the IP address range (i.e., within the IP address range) for the edge AS site 752 or the edge AS 750 defined in the traffic routing SLA. In this case, there is a match, and the new DNS function 722 triggers the core CP part 718 to dynamically activate LBO at the breakout site 704, as illustrated in FIG. 7E. In other words, the new DNS function 722 triggers the core CP part 718 to dynamically activate a ULCL 756 and a UPF 758 in a core UP part 760 at the breakout site 704 to provide LBO for the PDU session of the UE 734, as illustrated in FIG. 7F. Note that while the ULCL 756 is in the core UP part 760 in this embodiment, the ULCL 756 may alternatively be implemented in the RAN (i.e., at the radio site 702 as part of or in association with the RAN UP part 708. Also note that the trigger from the new DNS function 722 preferably includes an indication of the specific site at which LBO is being triggered. There are different possibilities for this indication of the actual site.

The new DNS function 722 also returns the DNS response to the UE 734, as illustrated in FIG. 7G. Thereafter, optimal traffic routing is enabled. In other words, traffic between the AC 738 and the edge AS 750 is routed, by the ULCL 756, using LBO, as illustrated in FIG. 7H.

Note that, in another embodiment, the IP address returned in the DNS response from the edge site DNS 754 may match an IP address range of another traffic routing SLA for another edge site or edge AS that also serves the FQDN included in the DNS query from the UE 734 and has an edge site/AS location that matches the current location of the UE 734. In this case, the new DNS function 722 triggers the core CP part 718 to dynamically activate LBO at a breakout site for this other edge site/AS. In other words, the new DNS function 722 triggers the core CP part 718 to dynamically activate a ULCL and a UPF in a core UP 760 at the breakout site to provide LBO for the PDU session of the UE 734 to the other edge site/AS.

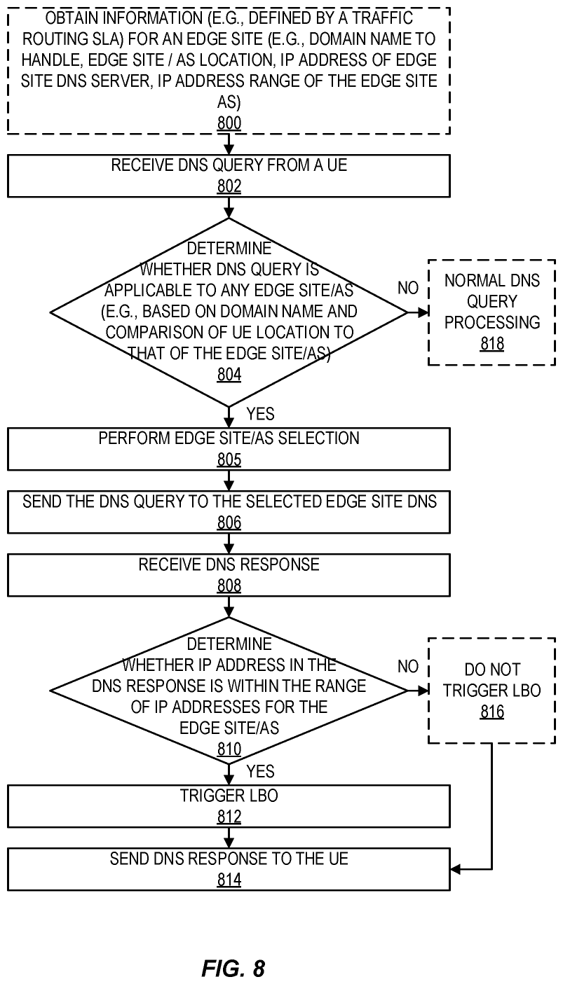

### FIG. 8

FIG. 8 is a flow chart that illustrates the operation of the new DNS function 722 in accordance with the embodiment described above with respect to FIGS. 7A through 7H. Optional steps are represented by dashed lines. As illustrated, the new DNS function 722 obtains (e.g., is configured with) the information for the edge AS site 752 (e.g., the information from the traffic routing SLA described above) (step 800). The new DNS function 722 receives a DNS query from the UE 734 (step 802) and determines whether the DNS query is applicable to any edge AS site or edge AS (step 804). More specifically, the new DNS function 722 determines whether the FQDN included in the DNS query matches the domain name handled by any traffic routing SLA information set defined any traffic routing SLA of any edge AS site or edge AS for which the new DNS function 722 is configured. If this is not the case, then normal DNS query processing is performed (step 818) (e.g., the new DNS function 722 forwards the DNS query to the DNS infrastructure in the normal manner (e.g., via the MNO DNS 720 or other DNS server)). If the FQDN included in the DNS query is part of one or more traffic routing SLA information sets, then the new DNS function 722 checks the current location of the UE 734 against the edge site/AS location in the traffic routing SLA information set(s) that match the FQDN included in the DNS query. If there are no matches, then normal DNS query process (step 818) is performed.

However, if there are one or more traffic routing information sets that both match the FQDN included in the received DNS query and have edge site/AS locations that match the UE location, then the DNS query is applicable to the corresponding one or more edge sites/ASs. As such, the new DNS function 722 performs edge site/AS selection (step 805). In particular, if the UE location matches the edge site/AS location from more than one of the traffic routing SLA information sets that matched the FQDN included in the DNS query, then the new DNS function 722 selects the edge site/AS corresponding one of those traffic routing SLA information sets (e.g., selects the edge site/AS that corresponds to one of those traffic routing SLA information sets for which the UE location most closely matches (e.g., is closest to) the edge site/AS location). If there is only one traffic routing SLA information set for which the UE location matches the edge site/AS location, then the edge site/AS that corresponds to that traffic routing SLA information set is selected. In the illustrated example, the selected SLA information set is that for the edge AS site 752/edge AS 750. As such, the edge AS site 752/edge AS 750 is selected. Note that in the discussion above, the new DNS function 722 first checks the FQDN and then checks location. However, the new DNS function 722 may alternatively check the location first and then check the FQDN.

Upon selecting the edge AS site 752/edge AS 750, the new DNS function 722 sends the DNS query to the edge site DNS 754 (e.g., using the IP address of the edge site DNS 754 provided by the traffic routing SLA) (step 806). The new DNS function 722 receives a DNS response (step 808) and determines whether the IP address included in the DNS response is one that is served by the edge AS site 752 or edge AS 750 (e.g., is within the IP address range defined in the traffic routing SLA for the edge AS site 752 or edge AS 750) (step 810). If so, the new DNS function 722 triggers activation of LBO (e.g., triggers activation of the ULCL 756 and the UPF 758 at the respective breakout site 704) (step 812) and sends the DNS response to back towards the UE 734 (step 814). If the IP address in the DNS response is not one served by the edge AS 750, the new DNS function 722 does not trigger activation of LBO (step 816) and sends the DNS response towards the UE 734 (step 814).

Note that, in another embodiment, the IP address returned in the DNS response from the edge site DNS 754 may match an IP address range of another traffic routing SLA for another edge site or edge AS that also serves the FQDN included in the DNS query from the UE 734 and has an edge site/AS location that matches the current location of the UE 734. In this case, the new DNS function 722 triggers the core CP part 718 to dynamically activate LBO at a breakout site for this other edge site/AS. In other words, the new DNS function 722 triggers the core CP part 718 to dynamically activate a ULCL and a UPF in a core UP 760 at the breakout site to provide LBO for the PDU session of the UE 734 to the other edge site/AS.

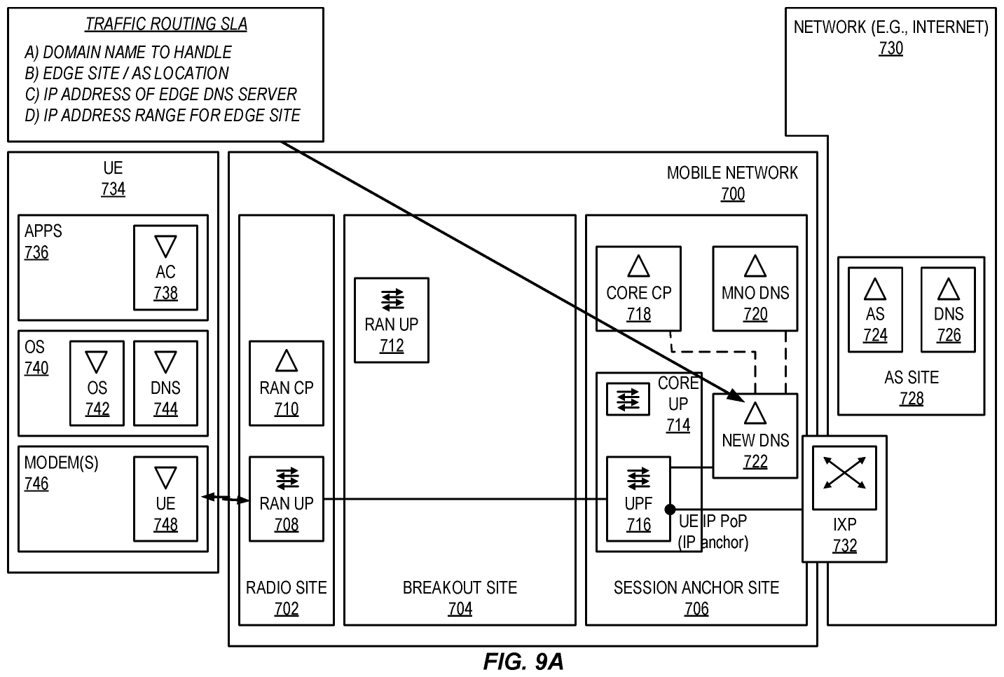

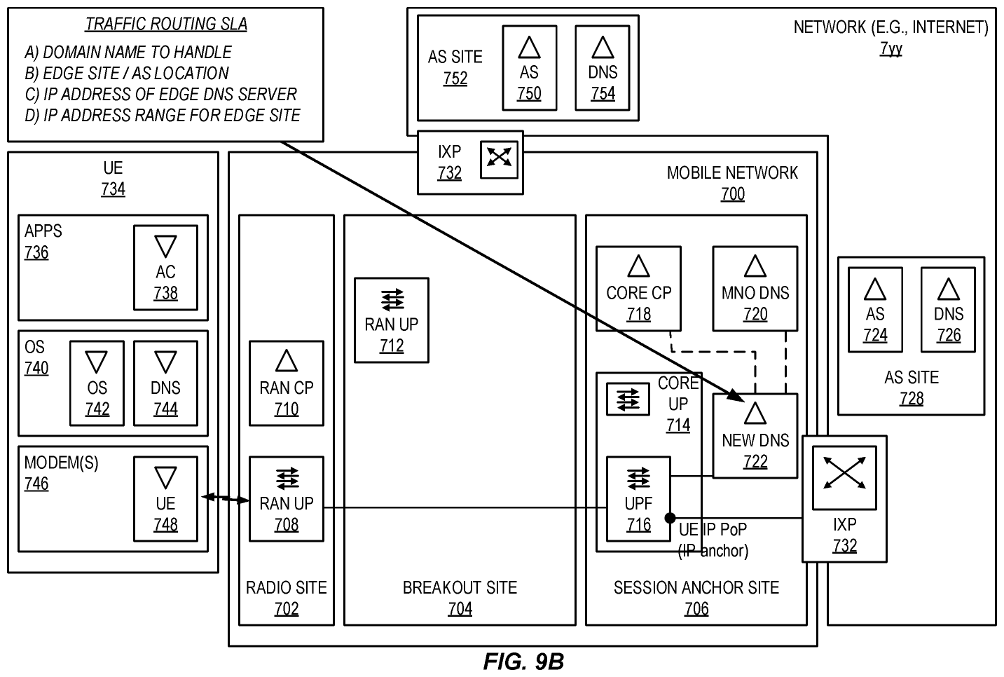

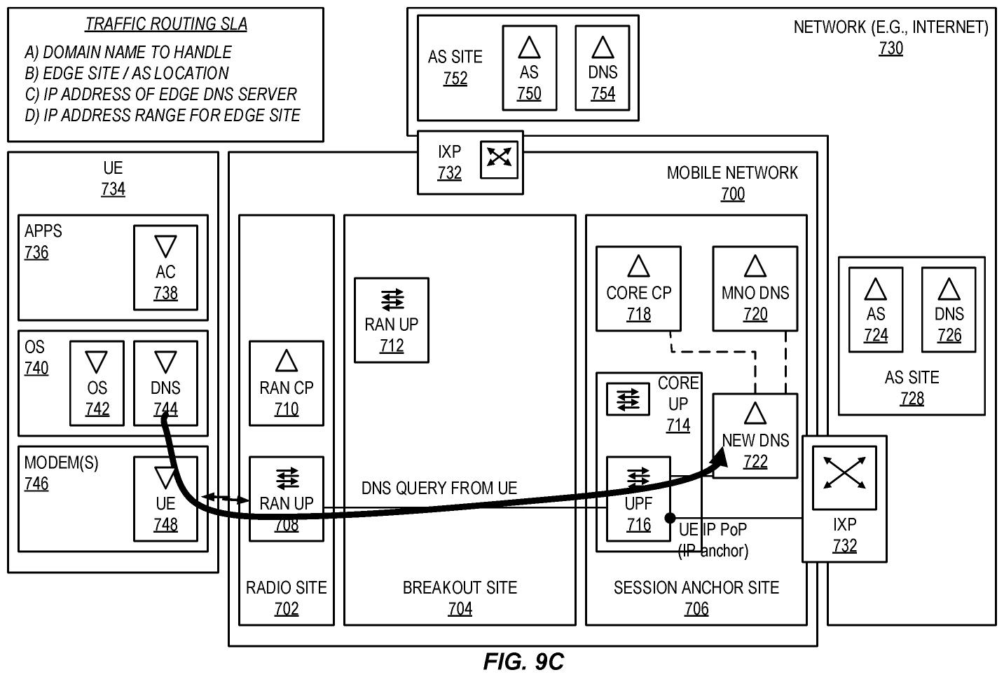

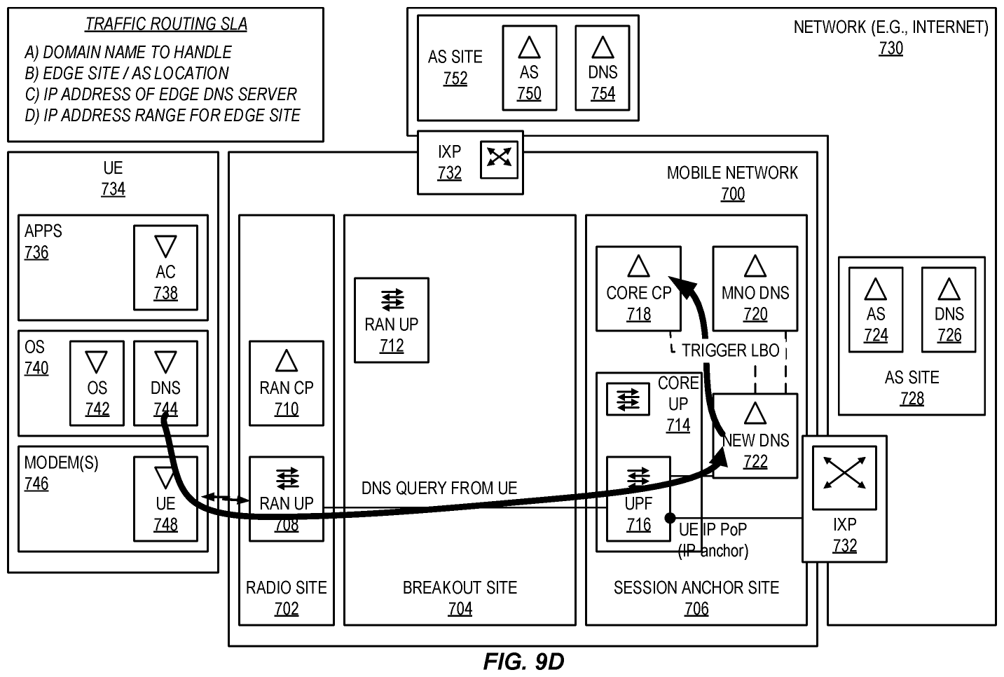

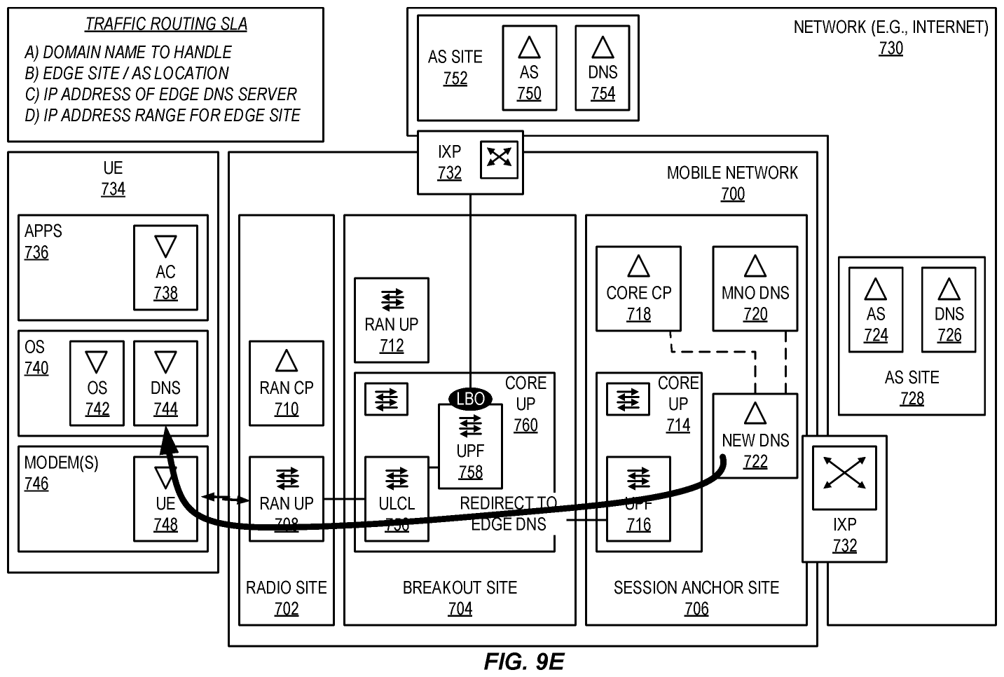

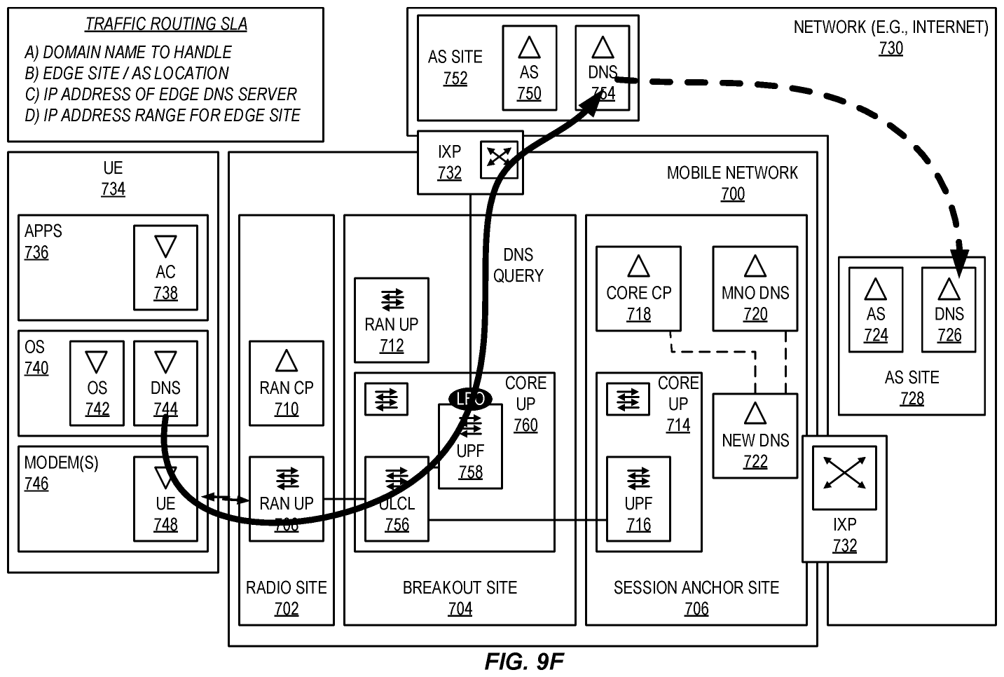

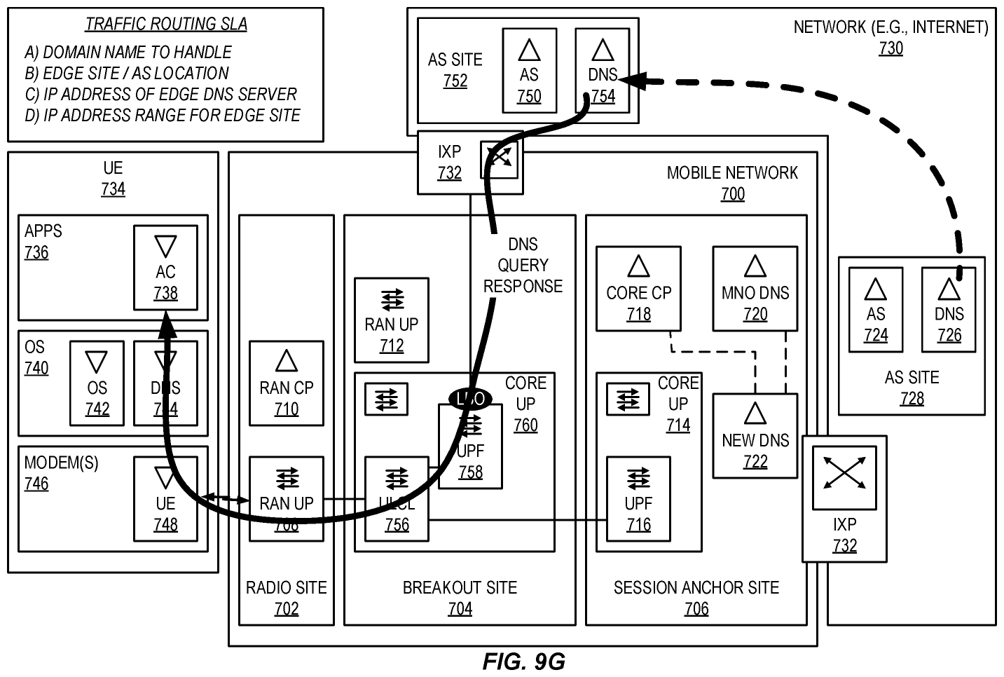

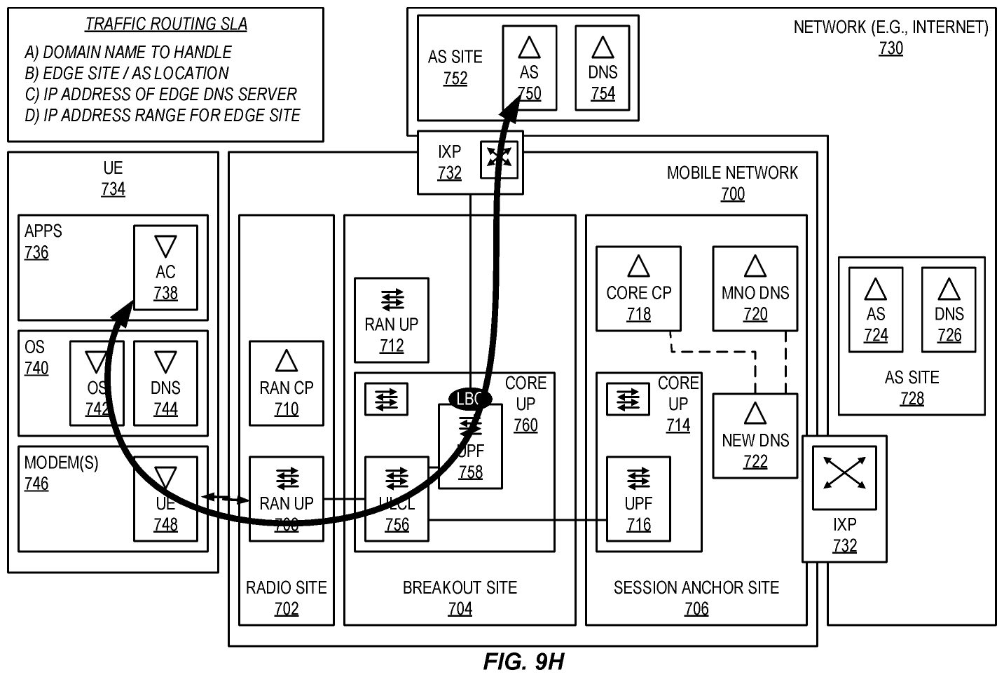

### FIGS. 9A-9H

FIGS. 9A through 9H illustrate an alternative embodiment of the present disclosure. As illustrated in FIG. 9A, the traffic routing SLA is defined between the operator of the mobile network 700 and the service provider associated with the AS 724, and the new DNS function 722 is configured with the traffic routing SLA information, as described above. Note, however, that in this embodiment, the traffic routing SLA need not define an IP address range for the edge AS site 752 or edge AS 750. Looking at FIG. 9B, the service provider deploys the edge AS 750 and the edge site DNS 754 at the edge AS site 752. As illustrated in FIG. 9C, the UE 734, and in particular the AC 738 at the UE 734, performs a DNS query to resolve an IP address of the AS 724. The response may either be an IP address of the edge AS 750 or the (central) AS 724. The DNS query from the UE 734 is propagated through the mobile network 700 to the new DNS function 722.

In this embodiment, the new DNS function 722 (which may be a DNS server) first checks if the FQDN included in the DNS query is part of any traffic routing SLA information set defined by any traffic routing SLA(s) for which the new DNS 722 has been configured. If this is not the case, then the new DNS function 722 forwards the DNS query to the DNS infrastructure in the normal manner (e.g., via the MNO DNS 720 or other DNS server). If the FQDN included in the DNS query is part of one or more traffic routing SLA information sets, then the new DNS function 722 checks the current location of the UE 734 against the edge site/AS location in the traffic routing SLA information set(s) that matched the FQDN included in the DNS query. If the current location of the UE 734 does not match the edge site/AS location of any of the matching traffic routing SLA information set(s), then the new DNS function 732 forwards the DNS query to the DNS infrastructure in the normal manner, e.g. via the MNO DNS 720 or other DNS servers.

If the UE location matches the edge site/AS location from more than one of the traffic routing SLA information sets that matched the FQDN included in the DNS query, then the new DNS function 722 selects the traffic routing SLA information set for which the UE location most closely matches (e.g., is closest to) the edge site/AS location. If there is only one traffic routing SLA information set for which the UE location matches the edge site/AS location, then that traffic routing SLA information set is selected. Note that in the discussion above, the new DNS function 722 first checks the FQDN and then checks location. However, the new DNS function 722 may alternatively check the location first and then check the FQDN.

In the illustrated example, the selected SLA information set is that for the edge AS site 752 (i.e., the edge AS 750), and the new DNS function 722 triggers the core CP part 718 to dynamically activate LBO at the breakout site 704, as illustrated in FIG. 9D. In other words, the new DNS function 722 triggers the core CP part 718 to dynamically activate a ULCL 756 and a UPF 758 at the breakout site 704 to provide LBO for the PDU session of the UE 734. Note that the trigger from the new DNS function 722 preferably includes an indication of the specific site at which LBO is being triggered. There are different possibilities for this indication of the actual site. In addition, the new DNS function 722 redirects the UE 734 (and in particular the DNS function 744 of the UE 734) to the edge site DNS 754 using the IP address defined in the traffic routing SLA for the edge site DNS 754, as illustrated in FIG. 9E.

Upon being redirected, the UE 734, and in particular the DNS function 744 of the UE 734, sends the DNS query to the IP address of the edge site DNS 754, as illustrated in FIG. 9F. Since LBO has been activated, the ULCL 756 routes the DNS query to the edge site DNS 754 via the UPF 758 using LBO. As illustrated in FIG. 9F, the edge site DNS 754 may decide to serve the DNS query locally or the edge site DNS 754 may forward the DNS query to a more central AS DNS server (e.g., the AS site DNS 726). In the latter case, the edge site DNS location is used by the central AS site DNS to decide where the AS should be selected. In the shown example, the edge AS 750 at the edge AS site 752 is selected, either by the edge site DNS 754 or by the central AS site DNS. The DNS response is returned to the UE 734, as illustrated in FIG. 9G. Thereafter, optimal traffic routing is enabled. In other words, traffic between the AC 738 and the edge AS 750 is routed, by the ULCL 756, using LBO, as illustrated in FIG. 9H.

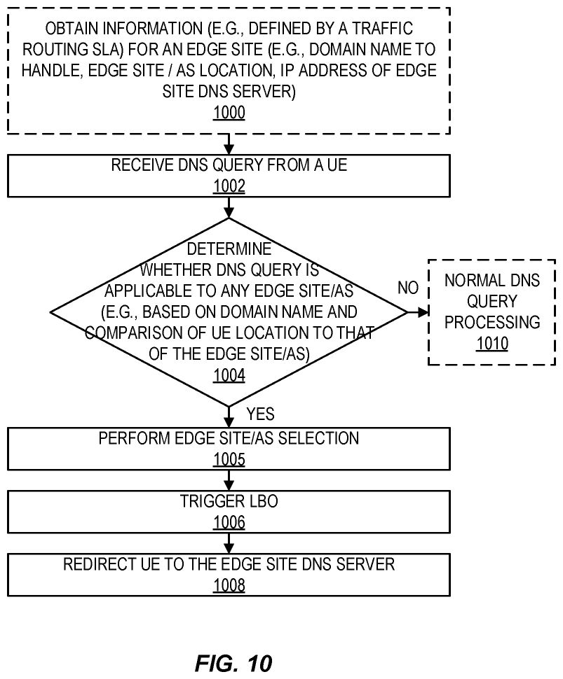

### FIG. 10

FIG. 10 is a flow chart that illustrates the operation of the new DNS function 722 in accordance with the embodiment described above with respect to FIGS. 9A through 9H. Optional steps are represented by dashed lines. As illustrated, the new DNS function 722 obtains (e.g., is configured with) the information for the edge AS site 752 (e.g., the information from the traffic routing SLA described above) (step 1000). The new DNS function 722 receives a DNS query from the UE 734 (step 1002) and determines whether the DNS query is applicable to any edge AS site or edge AS (step 1004). More specifically, the new DNS function 722 determines whether the FQDN included in the DNS query matches the domain name handled by any traffic routing SLA information set defined any traffic routing SLA of any the edge AS site or edge AS for which the new DNS function 722 is configured. If this is not the case, then normal DNS query processing is performed (step 1010) (e.g., the new DNS function 722 forwards the DNS query to the DNS infrastructure in the normal manner (e.g., via the MNO DNS 720 or other DNS server)). If the FQDN included in the DNS query is part of one or more traffic routing SLA information sets, then the new DNS function 722 checks the current location of the UE 734 against the edge site/AS location in the traffic routing SLA information set(s) that match the FQDN included in the DNS query. If there are no matches, then normal DNS query process (step 1010) is performed.

However, if there are one or more traffic routing information sets that both match the FQDN included in the received DNS query and have edge site/AS locations that match the UE location, then the DNS query is applicable to the corresponding one or more edge sites/ASs. As such, the new DNS function 722 performs edge site/AS selection (step 1005). In particular, if the UE location matches the edge site/AS location from more than one of the traffic routing SLA information sets that matched the FQDN included in the DNS query, then the new DNS function 722 selects the edge site/AS corresponding one of those traffic routing SLA information sets (e.g., selects the edge site/AS that corresponds to one of those traffic routing SLA information sets for which the UE location most closely matches (e.g., is closest to) the edge site/AS location). If there is only one traffic routing SLA information set for which the UE location matches the edge site/AS location, then the edge site/AS that corresponds to that traffic routing SLA information set is selected. In the illustrated example, the selected SLA information set is that for the edge AS site 752/edge AS 750. As such, the edge AS site 752/edge AS 750 is selected. Note that in the discussion above, the new DNS function 722 first checks the FQDN and then checks location. However, the new DNS function 722 may alternatively check the location first and then check the FQDN.

Upon selecting the edge AS site 752/edge AS 750, the new DNS function 722 triggers activation LBO (e.g., triggers activation of the ULCL 756 and the UPF 758 at the respective breakout site 704) (step 1006) and redirects the UE 734 to the edge site DNS 754 (step 1008). If the DNS query is determined to not be applicable to the edge AS site 752 (or any other edge site for which the new DNS function 722 is configured with the respective traffic routing SLA information), the new DNS function 722 provides the DNS query for normal DNS processing (e.g., forwards the DNS query to the MNO DNS 720) (step 1010).

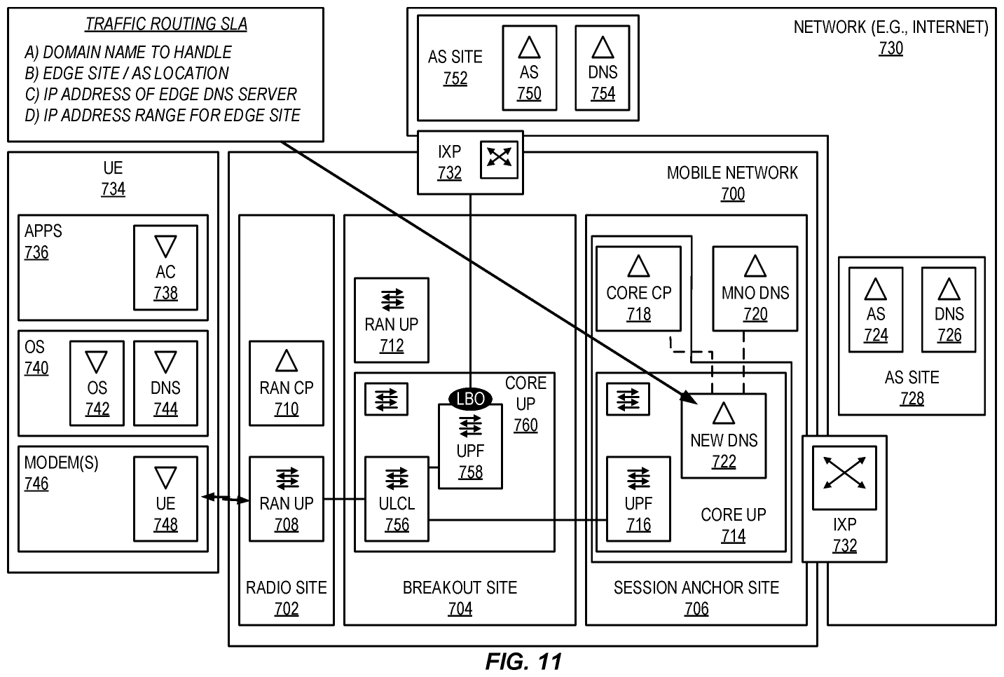

### FIG. 11

FIG. 11 illustrates an alternative embodiment in which the new DNS function 722 is integrated into the core UP part 714. In this embodiment, existing signaling and/or triggers between the core UP part 714 and the core CP part 718 may be used to trigger activation/deactivation of LBO. Otherwise, the operation of the system for LBO activation/deactivation is the same as described above. Further, in some embodiments, the core CP part 718, the core UP part 714, and the new DNS function 722 may be integrated.

### FIG. 12

FIG. 12 illustrates another alternative embodiment in which the edge site DNS 754 is replaced with a breakout site DNS 1200. In this embodiment, the breakout site DNS 1200 is populated with the rules/information for resolving DNS queries for the edge AS site 752. In addition, the address information of the local site DNS 1200 indicates the location of the UE to the AS site DNS 726 located at an AS site 728. Otherwise, the operation of the system for LBO activation/deactivation is the same as described above.

It should be noted that while the embodiments described herein focus on LBO at the breakout site 704 using the ULCL 756 in the core UP part 760, the present disclosure is not limited thereto. Alternatively, the LBO may use a ULCL at the radio site 702 as described in U.S. Provisional Patent Application Ser. No. 62/878,982, filed Jul. 26, 2019, which is attached hereto as Appendix A. Thus, in some alternative embodiments, dynamic activation of LBO includes dynamic activation/deactivation of the ULCL in the radio site.

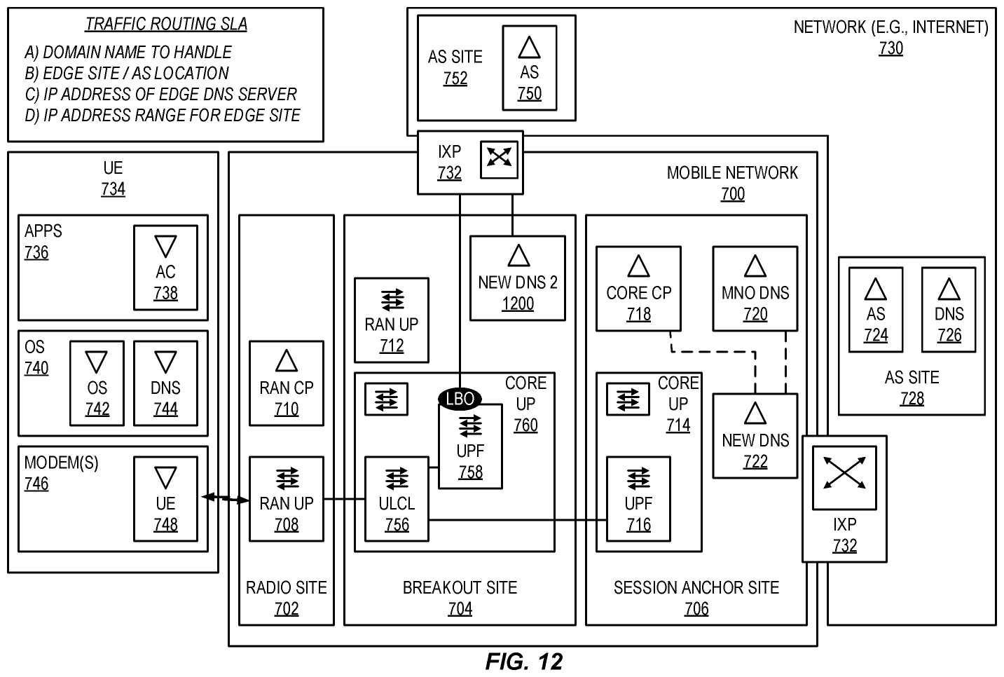

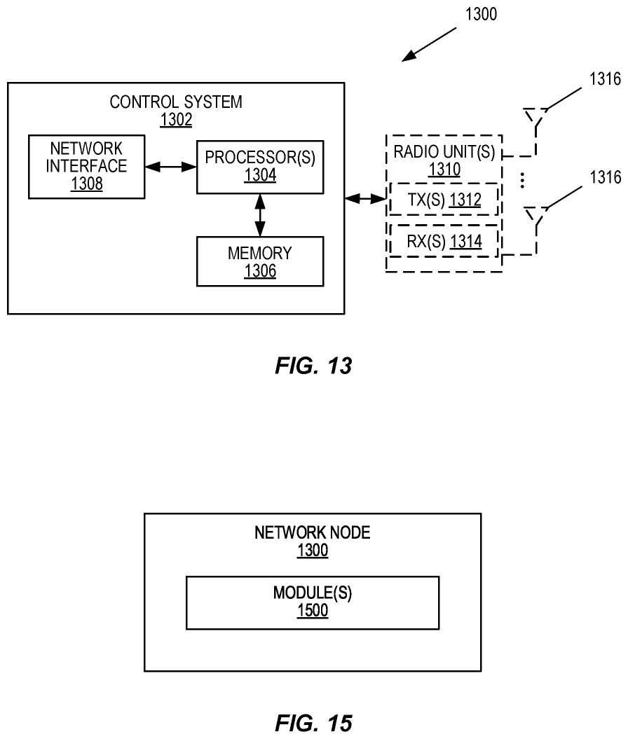

### FIG. 13

FIG. 13 is a schematic block diagram of a network node 1300 according to some embodiments of the present disclosure. The network node 1300 may be a network node that implements the new DNS function 722 or any other network node described above with respect to FIGS. 7A-7H, FIG. 8, FIGS. 9A-9H, FIG. 10, FIG. 11, and/or FIG. 12. As illustrated, the network node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In some embodiments, the network node 1300 is a radio access node (e.g., a base station 302), and the network node 1300 also includes one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a network node 1300 as described herein (e.g., one or more functions of the new DNS function 722 or any other network node described above with respect to FIGS. 7A-7H, FIG. 8, FIGS. 9A-9H, FIG. 10, FIG. 11, and/or FIG. 12, as described herein). In some embodiments, the function(s) are implemented in software that is stored, e.g., in the memory 1306 and executed by the one or more processors 1304.

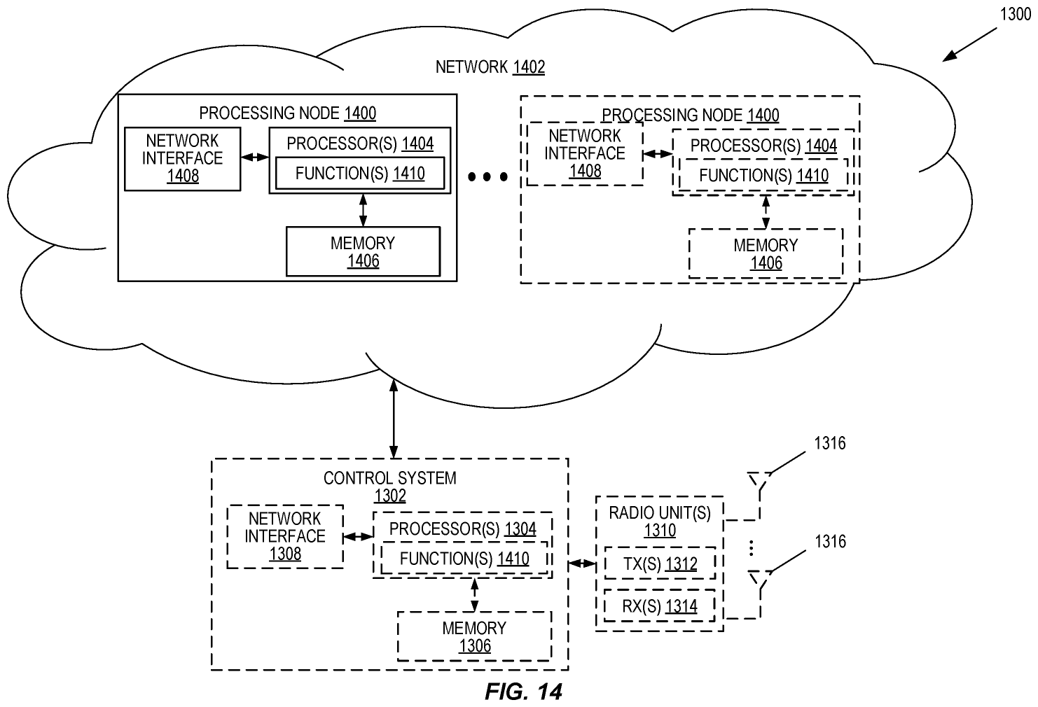

### FIG. 14

FIG. 14 is a schematic block diagram that illustrates a virtualized embodiment of the network node 1300 according to some embodiments of the present disclosure. This discussion is equally applicable to other types of network nodes. Further, other types of network nodes may have similar virtualized architectures.

As used herein, a “virtualized” network node is an implementation of the network node 1300 in which at least a portion of the functionality of the network node 1300 is implemented as a virtual component(s) (e.g., via a virtual machine(s) executing on a physical processing node(s) in a network(s)). As illustrated, in this example, the network node 1300 includes one or more processing nodes 1400 coupled to or included as part of a network(s) 1402. Each processing node 1400 includes one or more processors 1404 (e.g., CPUs, ASICs, FPGAs, and/or the like), memory 1406, and a network interface 1408. In some embodiments, the network node 1300 is a radio access node, and the network node 1300 also includes the control system 1302 and/or the one or more radio units 1310, as described above. Notably, in some embodiments, the control system 1302 may not be included, in which case the radio unit(s) 1310 communicate directly with the processing node(s) 1400 via an appropriate network interface(s).

In this example, functions 1410 of the network node 1300 described herein (e.g., one or more functions of the new DNS function 722 or any other network node described above with respect to FIGS. 7A-7H, FIG. 8, FIGS. 9A-9H, FIG. 10, FIG. 11, and/or FIG. 12, as described herein) are implemented at the one or more processing nodes 1400 or distributed across the control system 1302 and the one or more processing nodes 1400 in any desired manner. In some particular embodiments, some or all of the functions 1410 of the network node 1300 described herein are implemented as virtual components executed by one or more virtual machines implemented in a virtual environment(s) hosted by the processing node(s) 1400.

In some embodiments, a computer program including instructions which, when executed by at least one processor, causes the at least one processor to carry out the functionality of network node 1300 or a node (e.g., a processing node 1400) implementing one or more of the functions 1410 of the network node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 15

FIG. 15 is a schematic block diagram of the network node 1300 according to some other embodiments of the present disclosure. The network node 1300 includes one or more modules 1500, each of which is implemented in software. The module(s) 1500 provide the functionality of the network node 1300 described herein (e.g., one or more functions of the new DNS function 722 or any other network node described above with respect to FIGS. 7A-7H, FIG. 8, FIGS. 9A-9H, FIG. 10, FIG. 11, and/or FIG. 12, as described herein). This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

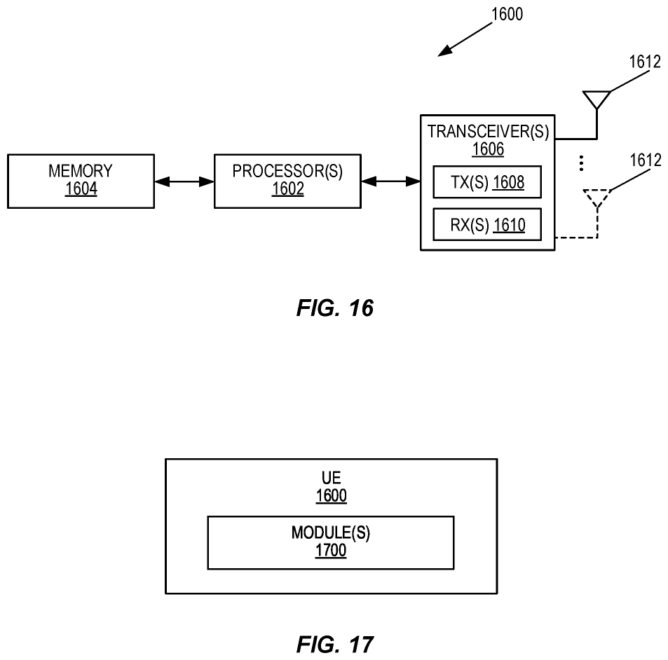

### FIG. 16

FIG. 16 is a schematic block diagram of a UE 1600 according to some embodiments of the present disclosure. The UE 1600 may be, e.g., the UE 734. As illustrated, the UE 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the UE 1600 described above may be fully or partially implemented in software that is, e.g., stored in the memory 1604 and executed by the processor(s) 1602. Note that the UE 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the UE 1600 and/or allowing output of information from the UE 1600), a power supply (e.g., a battery and associated power circuitry), etc.

In some embodiments, a computer program including instructions which, when executed by at least one processor, causes the at least one processor to carry out the functionality of the UE 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 17

FIG. 17 is a schematic block diagram of the UE 1600 according to some other embodiments of the present disclosure. The UE 1600 includes one or more modules 1700, each of which is implemented in software. The module(s) 1700 provide the functionality of the UE 1600 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Some Embodiments

While not being limited thereto, some example embodiments of the present disclosure are provided below.
1. A method performed by a network node that implements a Domain Name System, DNS, function (722) in a mobile network (700), the method comprising one or more of the following actions:

receiving (802; 1002) a DNS query that originated at a User Equipment, UE, (734);

in response to receiving (802; 1002) the DNS query, determining (804-810; 1004) to trigger dynamic activation of Local Break Out, LBO, for a session (e.g., a Protocol Data Unit, PDU, session) of the UE (734) at a breakout site (704) of the mobile network (700) for traffic between the UE (734) and an edge Application Server, AS, site (752) that is connected to the breakout site (704); and

upon determining (804-810; 1004) to trigger dynamic activation of LBO for the session of the UE (734) at the breakout site (704) of the mobile network (700) for traffic between the UE (734) and the edge AS site (752), triggering (812; 1006) dynamic activation of LBO for the session of the UE (734) at the breakout site (704) of the mobile network (700) for traffic between the UE (734) and the edge AS site (752).
2. The method of embodiment 1 wherein determining (804-810; 1004) to trigger dynamic activation of LBO for the session of the UE (734) at the breakout site (704) of the mobile network (700) for traffic between the UE (734) and the edge AS site (752) comprises:
   determining (804; YES) that the DNS query is applicable to one or more edge AS sites or one or more edge ASs located at the one or more edge sites (e.g., at any of a number of edge AS sites/edge ASs for which the DNS function (722) is configured); and
   selecting (805) the edge AS site (752) or an edge AS (750) at the edge AS site (752) from among the one or more edge sites or the one or more edge ASs;
   sending (806) the DNS query to either an edge site DNS (754) located at the edge AS site (752) or a breakout site DNS (1200) located at the breakout site (704);
   receiving (808) a DNS response comprising an Internet Protocol, IP, address for a domain name comprised in the DNS query; and
   determining (810) that the IP address comprised in the DNS response is within a set of IP addresses (e.g., within a range of IP addresses) for the edge AS site (752) or the edge AS (750).
3. The method of embodiment 2 wherein triggering (812; 1006) dynamic activation of LBO for the session of the UE (734) at the breakout site (704) of the mobile network (700) for traffic between the UE (734) and the edge AS site (752) comprises:

triggering (812) dynamic activation of LBO for the session of the UE (734) at the breakout site (704) of the mobile network (700) for traffic between the UE (734) and the edge AS site (752) upon determining (810, YES) that the IP address comprised in the DNS response is within the set of IP addresses for the edge AS site (752) or the edge AS (750).
4. The method of embodiment 2 further comprising sending (814) the DNS response to the UE (734) through the mobile network (700).
5. The method of any of embodiments 2-4 wherein determining (804) that the DNS query is applicable to the one or more edge AS sites or the one or more edge ASs comprises:

determining (804) that a domain name comprised in the DNS request matches a domain name handled by the one or more edge AS sites or the one or more edge ASs; and determining (804) that a current location of the UE (734) matches locations of the one or more edge AS sites or the one or more edge ASs.
6. The method of embodiment 1 wherein determining (804-810; 1004) to trigger dynamic activation of LBO for the session of the UE (734) at the breakout site (704) of the mobile network (700) for traffic between the UE (734) and the edge AS site (752) comprises:

determining (1004) that the DNS query is applicable to one or more edge AS sites or one or more edge ASs located at the one or more edge sites; and

selecting (1005) the edge AS site (752) or the edge AS (750) from among the one or more edge AS sites or the one or more edge ASs.
7. The method of embodiment 6 wherein triggering (812; 1006) dynamic activation of LBO for the session of the UE (734) at the breakout site (704) of the mobile network (700) for traffic between the UE (734) and the edge AS site (752) comprises:

triggering (1006) dynamic activation of LBO for the session of the UE (734) at the breakout site (704) of the mobile network (700) for traffic between the UE (734) and the edge AS site (752) upon selecting (1005) the edge AS site (752) or the edge AS (750).
8. The method of embodiment 7 further comprising redirecting (1008) the UE (734) to send the DNS query to either an edge site DNS (754) located at the edge site (752) or a breakout site DNS (1200) located at the breakout site (704).
9. The method of any one of embodiments 1 to 8 wherein triggering (812; 1006) dynamic activation of LBO for the session of the UE (734) at the breakout site (704) of the mobile network (700) for traffic between the UE (734) and the edge AS site (752) comprises triggering dynamic activation of:

a user plane function (758) in a core user plane part (760) at the breakout site (704), the user plane function (758) being connected to the edge AS site (752); and

an uplink classifier (756) that directs traffic from the session of the UE (734) that is intended for the edge AS site (752) to the edge AS site (752) via the user plane function (758).
10. The method of embodiment 9 wherein the uplink classifier (756) is implemented in the core user plane part (760) at the breakout site (704).
11. The method of embodiment 9 wherein the uplink classifier (756) is implemented in a Radio Access Network, RAN, of the mobile network (700) (e.g., within or in association with a RAN user plane part (708) at a radio site (702) of the mobile network (700)).
12. The method of any one of embodiments 1 to 11 wherein determining (804-810; 1004) to trigger dynamic activation of LBO for the session of the UE (734) at the breakout site (704) of the mobile network (700) for traffic between the UE (734) and the edge AS site (752) comprises determining (804-810; 1004) to trigger dynamic activation of LBO for the session of the UE (734) at the breakout site (704) of the mobile network (700) for traffic between the UE (734) and the edge AS site (752) based on information defined in a traffic routing service level agreement between an operator of the mobile network (700) and a service provider associated with the edge AS site (752).
13. The method of embodiment 12 wherein the information defined in the traffic routing service level agreement comprises a domain name handled by the edge AS site (752) and location information for the edge AS site (752) or edge AS (750).
14. The method of embodiment 13 wherein the information defined in the traffic routing service level agreement further comprises an Internet Protocol, IP, address of the edge site DNS (754) at the edge AS site (752).
15. The method of embodiment 13 or 14 wherein the information defined in the traffic routing service level agreement further comprises a set of IP addresses for the edge AS site (752) and/or the edge AS (750).
16. A network node adapted to perform the method of any of embodiments 1 to 15.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Abbreviations

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
4G Fourth Generation
5G Fifth Generation
5GC Fifth Generation Core
5GS Fifth Generation System
AC Application Client
AF Application Function
AMF Access and Mobility Function
AN Access Network
AP Access Point
AUSF Authentication Server Function
CP Control Plane
CPF Control Plane Function
CU-CP Central Unit Control Plane
CU-UP Central Unit User Plane
DN Data Network
DNS Domain Name System
DU Distributed Unit
eNB Enhanced or Evolved Node B
EPC Evolved Packet Core
EPS Evolved Packet System
E-UTRAN Evolved Universal Terrestrial Radio Access Network
FQDN Fully Qualified Domain Name
gNB New Radio Base Station
HSS Home Subscriber Server
IP Internet Protocol
LA Local Access Site
LBO Local Break Out
LTE Long Term Evolution
MME Mobility Management Entity
MNO Mobile Network Operator
NEF Network Exposure Function
NF Network Function
NG-C Next Generation Control Plane Interface
NG-eNB Next Generation Enhanced or Evovled Node B
NG-U Next Generation User Plane Interface
NG-RAN Next Generation Radio Access Network
NR New Radio
NRF Network Function Repository Function
NSSF Network Slice Selection Function
OS Operation System
PCF Policy Control Function
PDCP Packet Data Convergence Protocol
PDN Packet Data Network
PDU Protocol Data Unit
P-GW Packet Data Network Gateway
QoS Quality of Service
RAN Radio Access Network
RDC Regional Data Center
RF Radio Frequency
RRC Radio Resource Control
SCEF Service Capability Exposure Function
SLA Service Level Agreement
SMF Session Management Function
TR Technical Report
TS Technical Specification
UDM Unified Data Management
UE User Equipment
ULCL Uplink Classifier
UP User Plane
UPF User Plane Function

1. A method performed by a network node that implements a Domain Name System, DNS, function in a mobile network, the method comprising the actions:
receiving a DNS query that originated at a User Equipment, UE;
in response to receiving the DNS query, determining to trigger dynamic activation of Local Break Out, LBO, for a session of the UE at a breakout site of the mobile network for traffic between the UE and an edge Application Server, AS, site that is connected to the breakout site; and
upon determining to trigger dynamic activation of LBO for the session of the UE at the breakout site of the mobile network for traffic between the UE and the edge AS site, triggering dynamic activation of LBO for the session of the UE at the breakout site of the mobile network for traffic between the UE and the edge AS site.

2. The method of claim 1 wherein determining to trigger dynamic activation of LBO for the session of the UE at the breakout site of the mobile network for traffic between the UE and the edge AS site comprises:
determining that the DNS query is applicable to one or more edge AS sites or one or more edge ASs located at the one or more edge sites; and
selecting the edge AS site or an edge AS at the edge AS site from among the one or more edge sites or the one or more edge ASs;
sending the DNS query to either an edge site DNS located at the edge AS site or a breakout site DNS located at the breakout site;
receiving a DNS response comprising an Internet Protocol, IP, address for a domain name comprised in the DNS query; and
determining that the IP address comprised in the DNS response is within a set of IP addresses for the edge AS site or the edge AS.

3. The method of claim 2 wherein triggering dynamic activation of LBO for the session of the UE at the breakout site of the mobile network for traffic between the UE and the edge AS site comprises:
triggering dynamic activation of LBO for the session of the UE at the breakout site of the mobile network for traffic between the UE and the edge AS site upon determining that the IP address comprised in the DNS response is within the set of IP addresses for the edge AS site or the edge AS.

4. The method of claim 2 further comprising sending the DNS response to the UE through the mobile network.

5. The method of claim 2 wherein determining that the DNS query is applicable to the one or more edge AS sites or the one or more edge ASs comprises:
determining that a domain name comprised in the DNS request matches a domain name handled by the one or more edge AS sites or the one or more edge ASs; and
determining that a current location of the UE matches locations of the one or more edge AS sites or the one or more edge ASs.

6. The method of claim 1 wherein determining to trigger dynamic activation of LBO for the session of the UE at the breakout site of the mobile network for traffic between the UE and the edge AS site comprises:
determining that the DNS query is applicable to one or more edge AS sites or one or more edge ASs located at the one or more edge sites; and
selecting the edge AS site or the edge AS from among the one or more edge AS sites or the one or more edge ASs.

7. The method of claim 6 wherein triggering dynamic activation of LBO for the session of the UE at the breakout site of the mobile network for traffic between the UE and the edge AS site comprises:
triggering dynamic activation of LBO for the session of the UE at the breakout site of the mobile network for traffic between the UE and the edge AS site upon selecting the edge AS site or the edge AS

8. The method of claim 7 further comprising redirecting the UE to send the DNS query to either an edge site DNS located at the edge site or a breakout site DNS located at the breakout site.

9. The method of claim 1 wherein triggering dynamic activation of LBO for the session of the UE at the breakout site of the mobile network for traffic between the UE and the edge AS site comprises triggering dynamic activation of:
a user plane function in a core user plane part at the breakout site, the user plane function being connected to the edge AS site; and
an uplink classifier that directs traffic from the session of the UE that is intended for the edge AS site to the edge AS site via the user plane function.

10. The method of claim 9 wherein the uplink classifier is implemented in the core user plane part at the breakout site.

11. The method of claim 9 wherein the uplink classifier is implemented in a Radio Access Network, RAN, of the mobile network.

12. The method of claim 1 wherein determining to trigger dynamic activation of LBO for the session of the UE at the breakout site of the mobile network for traffic between the UE and the edge AS site comprises determining to trigger dynamic activation of LBO for the session of the UE at the breakout site of the mobile network for traffic between the UE and the edge AS site based on information defined in a traffic routing service level agreement between an operator of the mobile network and a service provider associated with the edge AS site.

13. The method of claim 12 wherein the information defined in the traffic routing service level agreement comprises a domain name handled by the edge AS site and location information for the edge AS site or edge AS.

14. The method of claim 13 wherein the information defined in the traffic routing service level agreement further comprises an Internet Protocol, IP, address of the edge site DNS at the edge AS site.

15. The method of claim 13 wherein the information defined in the traffic routing service level agreement further comprises a set of IP addresses for the edge AS site and/or the edge AS.

16. A network node adapted to:
processing circuitry configured to cause the network node to:
receive a Domain Name System, DNS, query that originated at a User Equipment, UE;
in response to receiving the DNS query, determine to trigger dynamic activation of Local Break Out, LBO, for a session of the UE at a breakout site of the mobile network for traffic between the UE and an edge Application Server, AS, site that is connected to the breakout site; and
upon determining to trigger dynamic activation of LBO for the session of the UE at the breakout site of the mobile network for traffic between the UE and the edge AS site, trigger dynamic activation of LBO for the session of the UE at the breakout site of the mobile network for traffic between the UE and the edge AS site.
